(19) United States
(12) Patent Application Publication
(10) Pub. No.: US 2013/0141752 A1
(43) Pub. Date: Jun. 6, 2013

(54) JOB CONTROL APPARATUS, JOB CONTROL SYSTEM, AND METHOD OF CONTROLLING PROCESSING JOB DATA

(71) Applicant: Takayori NISHIDA, Tokyo (JP)

(72) Inventor: Takayori NISHIDA, Tokyo (JP)

(73) Assignee: RICOH COMPANY, LTD., Tokyo (JP)

(21) Appl. No.: 13/684,825

(22) Filed: Nov. 26, 2012

(30) Foreign Application Priority Data
Dec. 6, 2011 (JP) 2011-266845

(51) Int. Cl. G06F 21/60

(52) U.S. Cl. CPC G06F 21/608
USPC 358/1.14

(57) ABSTRACT

A job control apparatus for controlling processing of job data by a job processing unit, includes a job control unit that determines whether stored job data which is in correspondence with a user is to be processed by the job processing unit upon a log-in of the user to use the job processing unit as a trigger based on a previously set predetermined condition that allows the stored job data to be processed by the job processing unit upon the log-in of the user.

### BACKGROUND OF THE INVENTION

1. Field of the Invention

The present invention relates to a technique of controlling a job.

2. Description of the Related Art

For example, a job control system in which stored job data of a user who is authenticated (hereinafter referred to as a “log-in user”) is printed in cooperation with a user authentication function is disclosed in Patent Document 1.

In such a job control system, first, job data input by a user is stored in a data processing apparatus such as a file server or the like, or in an electronic apparatus such as an image processing apparatus that processes image processing or the like. When the user moves to the electronic apparatus that processes the job data and the user is authenticated by the job control system, the stored job data of the log-in user is shown on the display of the electronic apparatus as a list (hereinafter referred to as a “job list”). Thus, the log-in user is to select job data to be processed among the job data included in the job list. When the user selects the job data, the job control system controls the electronic apparatus to process the selected job data.

With the above structure, an environment in which the user is capable of processing only the user's stored job data is provided. With this system, carrying away or stealing of a printed object by others can be prevented so that the output result of processing the job data can be secured.

However, according to the conventional method of controlling the job, the security of the output result and the convenience of a service are not in good balance for the user.

In the conventional job control system, the user needs to perform the following methods. First, the user stores job data to be processed in the data processing apparatus or in the electronic apparatus, moves to the electronic apparatus by which the job data is to be processed, performs the user authentication, selects the stored job data to be processed and instructs the apparatus to process the stored job data.

According to the above methods, although the output result can be secured, it is troublesome for the user on some occasions. For example, when the user needs to print documents for a meeting or the like, it is convenient for the user to quickly process (print) the job data. On the other hand, if the job data is permitted to be printed by the electronic apparatus without the user authentication in order to provide convenience for a user, it becomes difficult to ensure the security of the output result.

Thus, in controlling the job, convenience for the user is desired while ensuring the security of the output result when processing the job data.

### PATENT DOCUMENT

[Patent Document 1] Japanese Laid-open Patent Publication No. 2010-100007

### SUMMARY OF THE INVENTION

The present invention is made in light of the above problems, and provides a job control apparatus, a job control system and a method of controlling a job, by which convenience for a user can be improved while ensuring a security of an output result when processing job data.

According to an embodiment, there is provided a job control apparatus for controlling processing of job data by a job processing unit, including a job control unit that determines whether stored job data which is in correspondence with a user is to be processed by the job processing unit upon a log-in of the user to use the job processing unit as a trigger based on a previously set predetermined condition that allows the stored job data to be processed by the job processing unit upon the log-in of the user.

According to another embodiment, there is provided a job control system including an electronic apparatus including a job processing unit that processes job data; and a job control apparatus connected to the electronic apparatus via a predetermined data transmission line, including a job control unit that determines whether stored job data which is in correspondence with a user is to be processed by the job processing unit upon a log-in of the user to use the job processing unit as a trigger based on a previously set predetermined condition that allows the stored job data to be processed by the job processing unit upon the log-in of the user.

According to another embodiment, there is provided a method of controlling processing job data by a job processing unit, including determining whether stored job data which is in correspondence with a user is to be processed by the job processing unit upon a log-in of the user to use the job processing unit as a trigger based on a previously set predetermined condition that allows the stored job data to be processed by the job processing unit upon the log-in of the user.

Note that also arbitrary combinations of the above-described constituents, and any exchanges of expressions in the present invention, made among methods, devices, systems, recording media, computer programs and so forth, are valid as embodiments of the present invention.

### BRIEF DESCRIPTION OF THE DRAWINGS

Other objects, features and advantages of the present invention will become more apparent from the following detailed description when read in conjunction with the accompanying drawings.

FIG. 1 is a block diagram showing an example of a structure of a job control system;

FIG. 2 is a block diagram showing an example of a hardware structure of a job control apparatus of the embodiment;

FIG. 3 is a block diagram showing an example of a functional structure of the job control system;

FIG. 4 is a view showing an example of job management information of the embodiment;

FIG. 5 is a sequence diagram showing an example of a job control process of the embodiment;

FIG. 6 is a flowchart showing an example of an operation of determining whether to process job data of the embodiment;

FIG. 7 is a flowchart showing an example of an operation of determining whether to process job data of the embodiment;

FIG. 8 is a flowchart showing an example of an operation of determining whether to process job data of the embodiment;

FIG. 9 is a block diagram showing another example of a functional structure of the job control system;

FIG. 10 is a view showing an example of conditions for users;

FIG. 11 is a flowchart showing an example of an operation of determining whether to process the job data;

FIG. 12 is a sequence diagram showing an example of a job control process;

FIG. 13 is an example of an accepting display displayed on an operations panel of an image processing apparatus;

FIG. 14 is a sequence diagram showing an example of a job control process;

FIG. 15 is a flowchart showing an example of an operation of determining whether to process the job data;

FIG. 16 is a sequence diagram showing an example of a job control process;

FIG. 17 is a flowchart showing an example of an operation of determining whether to process the job data; and

FIG. 18 is a block diagram of showing another example of a structure of the job control function of an example.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

In the following embodiment, “job data” is print data and “processing job data” means printing the job data.

### First Embodiment

### (System Structure)

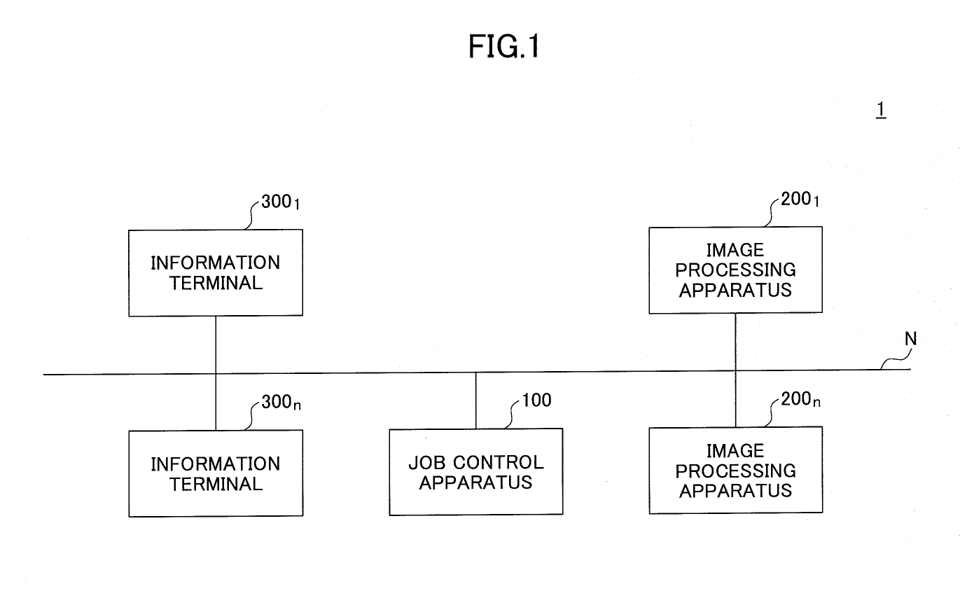

FIG. 1 is a block diagram showing an example of a structure of a job control system 1.

The job control system 1 includes one or plural information terminals 300₁ and 300ₙ (which may be simply referred to as a “information terminal 300”), one or more image processing apparatuses 200₁ and 200ₙ (which may be simply referred to as a “image processing apparatus 200”), and a job control apparatus 100 connected via a predetermined data transmission line N (for example, “LAN: Local Area Network”).

The information terminal 300 has a function of data processing and may be a Personal Computer (PC), a tablet PC or the like. The image processing apparatus 200 has a function of image processing and may be a scanner, a printer, a Multifunction Peripheral (MFP), a projector or the like.

The job control apparatus 100 stores and manages job data which is input from the information terminal 300 and controls processing of the stored job data at the image processing apparatus 200. The job control apparatus 100 may be a data processing apparatus. The job control apparatus 100 may be a server having the information terminal 300 or the image processing apparatus 200 as clients.

The job control system 1 provides a following service.

The information terminal 300 sends job data input by a user to the job control apparatus 100 to be stored. Upon receiving the job data, the job control apparatus 100 stores the job data in a predetermined memory area.

Thereafter, upon accepting an instruction from a user with authentication data, the image processing apparatus 200 performs a user authentication based on the authentication data. Then, when the user is authenticated, the image processing apparatus 200 sends a log-in notice of the user (log-in user), which indicates that the user is authenticated, to the job control apparatus 100.

Upon receiving the log-in notice, the job control apparatus 100 determines whether to have the job data be processed by the image processing apparatus 200 upon the log-in of user to the image processing apparatus 200 as a trigger based on information about the stored job data (which may be simply referred to as “job management information”) of the log-in user.

In this embodiment, the job control apparatus 100 stores a previously set predetermined condition that allows the stored job data to be processed by the image processing apparatus 200 upon the log-in of the user. The job control apparatus 100 determines whether to have the job data be processed by the image processing apparatus 200 upon the log-in of user as a trigger based on the job management information of the log-in user and the condition.

When the stored job data of the log-in user satisfies the condition and the job control apparatus 100 determines to have the job data be processed, the job control apparatus 100 sends the job data that satisfies the condition to the image processing apparatus 200 with a request to process the job data.

With the above operation, the job data of the log-in user is processed immediately by the image processing apparatus upon the log-in of the user.

On the other hand, when there is no job data that satisfies the condition and the job control apparatus 100 determines to not have the job data be processed, the job control apparatus 100 generates a job list of the log-in user based on the information about the stored job data of the log-in user, and sends the job list to the image processing apparatus 200 to be displayed.

Then, when the job list is displayed by the image processing apparatus 200, the log-in user selects job data to be processed. Then, the image processing apparatus 200 requests the job control apparatus 100 to send the job data selected by the log-in user. When the job data is obtained from the job control apparatus 100, the image processing apparatus 200 processes the job data.

According to the above system structure, the job control system 1 is capable of having the stored job data that satisfies the previously set predetermined condition processed by the image processing apparatus 200 upon the log-in of the user to the image processing apparatus 200 as a trigger.

### (Hardware Structure)

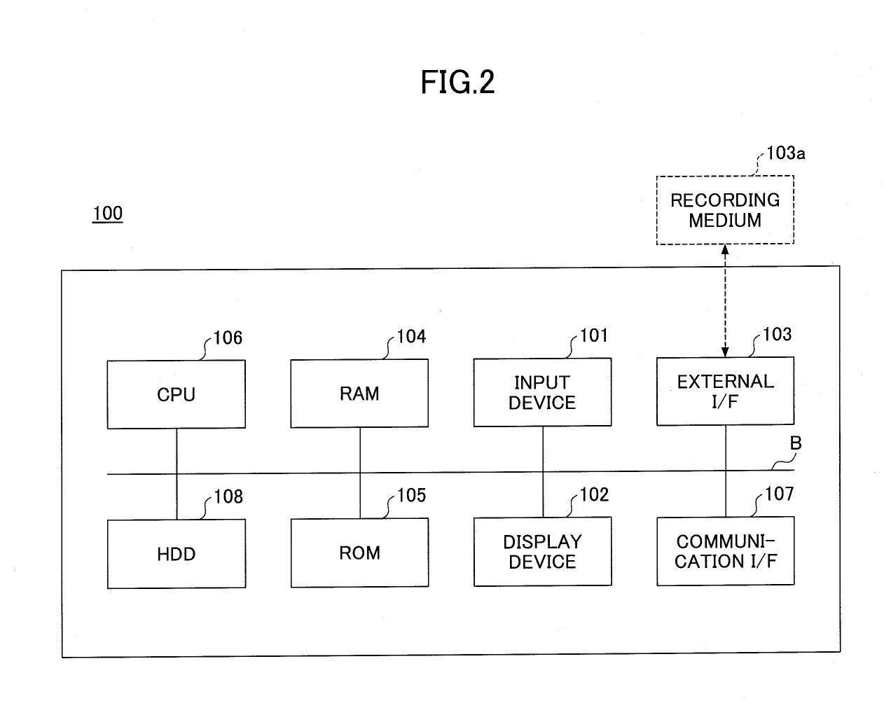

FIG. 2 is a block diagram showing an example of a hardware structure of the job control apparatus 100 of the embodiment.

The job control apparatus 100 includes an input device 101, a display device 102, an external interface (I/F) 103, a Random Access Memory (RAM) 104, a Read Only Memory (ROM) 105, a Central Processing Unit (CPU) 106, a communication I/F 107, a Hard Disk Drive (HDD) 108 and the like connected with each other via a BUS B.

The input device 101 includes a keyboard, a mouse or the like and is used for inputting various operational signals into the job control apparatus 100. The display device 102 includes a display or the like and displays a result processed by the job control apparatus 100.

The communication I/F 107 connects the job control apparatus 100 to a network such as the data transmission line N shown in FIG. 1. With the function of the communication I/F 107, the job control apparatus 100 is capable of communicating with other apparatuses such as the information terminal 300, the image processing apparatus 200 or the like.

The HDD 108 is a nonvolatile storage device storing programs or data. The programs or data stored in the HDD 108 may be an Operating System (OS) which is basic software controlling the entirety of the apparatus, application software providing various functions on the OS, or the like. The HDD 108 manages the programs or data stored therein by a predetermined file system and/or a Database (DB).

The external I/F 103 is an interface for an external device such as a recording medium 103a or the like. With the function of the external I/F 103, the job control apparatus 100 is capable of reading and/or writing data in the recording medium 103a via the external I/F 103. The recording medium 103a may be a floppy (registered trademark) disk, a Compact Disk (CD), a Digital Versatile Disk (DVD), an SD memory card, a Universal Serial Bus memory (USB memory) or the like.

The ROM 105 is a nonvolatile semiconductor memory (storage device) capable of storing data even when power is switched off. The ROM 105 stores Basic Input/Output System (BIOS) which is executed when initiating the job control apparatus 100, program or data for setting the OS or network, or the like.

The RAM 104 is a volatile semiconductor memory (storage device) temporarily storing programs or data.

The CPU 106 is an arithmetic unit which reads out the programs or data from the storage devices such as the HDD 108, the ROM 105 or the like on the RAM 104 and actualizes controlling of the entirety of the apparatus and functions on the apparatus.

As described above, according to the job control apparatus 100 of the embodiment, various processing services including controlling printing with the above hardware structure can be provided.

Although not shown in the drawings, the image processing apparatuses 200 and the information terminal 300 have the same hardware structures as explained above with reference to FIG. 2.

### (Job Control Function)

The job control function of the embodiment is explained.

Upon receiving the log-in notice of a user (hereinafter referred to as a “log-in user”) from the image processing apparatus 200, the job control apparatus 100 specifies the job management information of the log-in user among the job management information sets that manages the stored job data. The job control apparatus 100 determines whether to have the stored job data of the log-in user processed upon the log-in of the user to the image processing apparatus 200 as a trigger based on the specified job management information and the previously set predetermined condition.

Then, the job control apparatus 100 sends the job data that satisfies the condition with a request to process to the image processing apparatus 200. The job control apparatus 100 of the embodiment has such a job control function.

As described above, according to the conventional method of controlling the job, the security of the output result and the convenience of a service are not in good balance for the user. For example, when the job control system 1 is used in a business setting, it is necessary to quickly process the job data by the image processing apparatus 200 while ensuring the security of the processed result.

Thus, according to the job control apparatus 100 of the embodiment, a mechanism is provided by which the stored job data of the log-in user that satisfies the predetermined condition is sent to the image processing apparatus 200 to be processed upon the user log-in (user authentication) to the image processing apparatus 200.

With this, according to the job control system 1 of the embodiment, the user can have the facing image processing apparatus 200 process the job data with a simple operation and obtain the processed result. As a result, according to the job control system 1 of the embodiment, convenience for the user can be improved while ensuring the security of the output result when processing the job data.

The structure and operation of the job control function of the embodiment are explained.

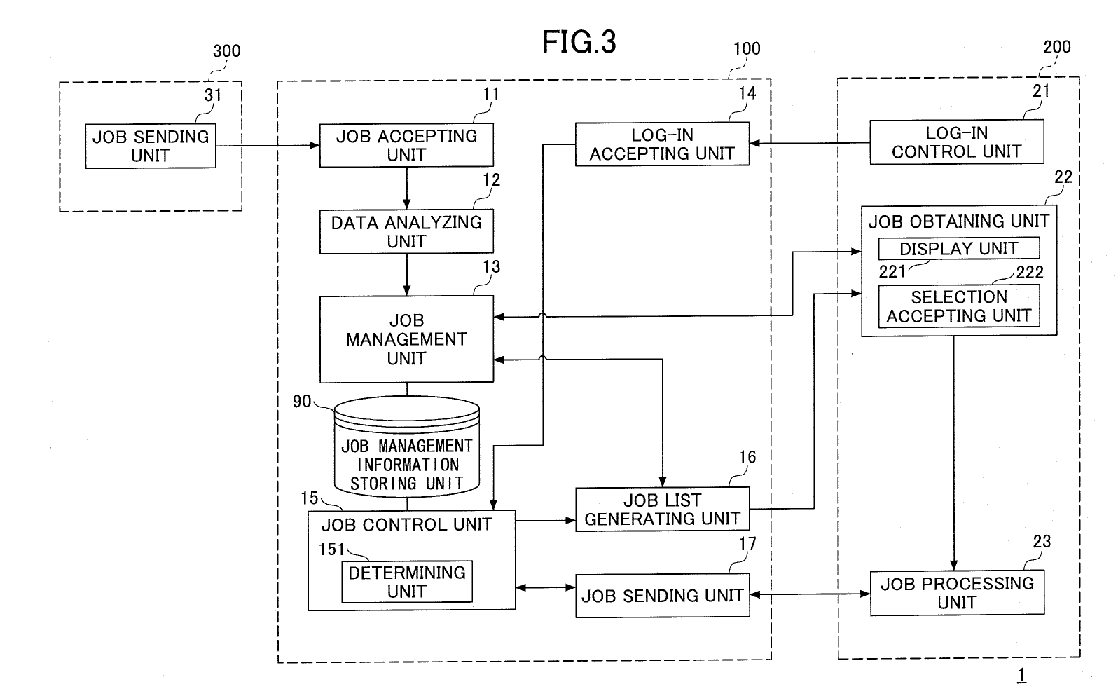

FIG. 3 is a block diagram showing an example of a functional structure of the job control system 1.

The job control apparatus 100 includes a job accepting unit 11, a data analyzing unit 12, a job management unit 13, a log-in accepting unit 14, a job control unit 15, a job list generating unit 16, a job sending unit 17 and the like to perform the job control function. The job control unit 15 includes a determining unit 151. The job control apparatus 100 further includes a job management information storing unit 90.

The image processing apparatus 200 includes a log-in control unit 21, a job obtaining unit 22, a job processing unit 23 and the like to perform the job control function. The job obtaining unit 22 includes a display unit 221 and a selection accepting unit 222. The information terminal 300 includes a job sending unit 31 and the like to perform the job control function.

As described above, the job control function of the embodiment is performed by a combination of the components.

### (Information Terminal 300)

The job sending unit 31 sends job data to be stored to the job control apparatus 100. The job sending unit 31 requests storing the job data by sending the job data to the job control apparatus 100. The “job data” may be print data generated by a printer driver installed in the information terminal 300, for example. However, the job data is not limited to the print data. The job data may be data processable by the job processing unit 23 of the image processing apparatus 200.

### (Image Processing Apparatus 200)

The log-in control unit 21 controls a log-in of a user to the image processing apparatus 200. The log-in control unit 21 performs a user authentication based on authentication data (for example “user ID” and a “password”) of a user who requests logging in accepted via a predetermined input interface. The “input interface” may be, for example an authentication image displayed on an operations panel (not shown in the drawings) of the image processing apparatus 200, a reader device (IC card reader or the like) that reads authentication data stored in a recording medium such as an Integrated Circuit card (IC Card) or the Like.

The log-in control unit 21 compares authentication data (accepted authentication data) of a user who requests logging in with authentication data of the user previously stored in the image processing apparatus 200 and determines whether the user is authenticated based on the compared result. When the accepted authentication data matches the authentication data of the user previously stored in the image processing apparatus 200, the log-in control unit 21 determines that the user who requests logging in is an authenticated user (hereinafter referred to as a “log-in user”) having a right to use the function of the image processing apparatus 200 or the like.

Alternatively, the log-in control unit 21 may send the accepted authentication data of the user who requests logging in to an authentication apparatus (not shown in the drawings) with which the image processing apparatus 200 is capable of communicating to request a user authentication. In this case, the log-in control unit 21 obtains the authenticated result.

When the log-in control unit 21 determines that the user is the authenticated user, the log-in control unit 21 sends a log-in notice indicating that the user is authenticated to the job control apparatus 100. In this embodiment, the log-in control unit 21 sends identification data (user ID) of the log-in user to the job control apparatus 100 as the log-in notice.

The job obtaining unit 22 obtains a job list of stored job data of the log-in user from the job control apparatus 100.

In the job obtaining unit 22, the display unit 221 displays the job list of the log-in user sent from the job control apparatus 100. The selection accepting unit 222 accepts a selection of job data to be processed among the job data included in the job list by the log-in user. Upon accepting the selection, the job obtaining unit 22 sends a request of obtaining the selected job data to the job control apparatus 100 and receives the job data from the job control apparatus 100.

The job processing unit 23 processes the job data in accordance with a request of processing the job data sent from the job control apparatus 100. After processing the job data, the job processing unit 23 sends a processed result of the job data to the job control apparatus 100 to be recorded.

### (Job Control Apparatus 100)

The job accepting unit 11 accepts job data to be stored from the information terminal 300.

The data analyzing unit 12 analyzes the job data sent from the information terminal 300. The data analyzing unit 12 analyzes the job data in accordance with a predetermined rule (for example a data format or the like) and obtains a bibliography, an appendix or the like of the job data as an analyzing result. The “bibliography” is data added to the job data when the job data is generated in the information terminal 300 (for example, when the job data is generated by the printer driver or the like as explained above) based on original data such as application data or the like. The “appendix” is set data added to the job data accepted by a user when the job data is sent from the information terminal 300 such as a proxy user who is capable of processing the job data, date (hereinafter referred to as starting date) from which the job data is to be processed upon a log-in of the user as a trigger, or the like.

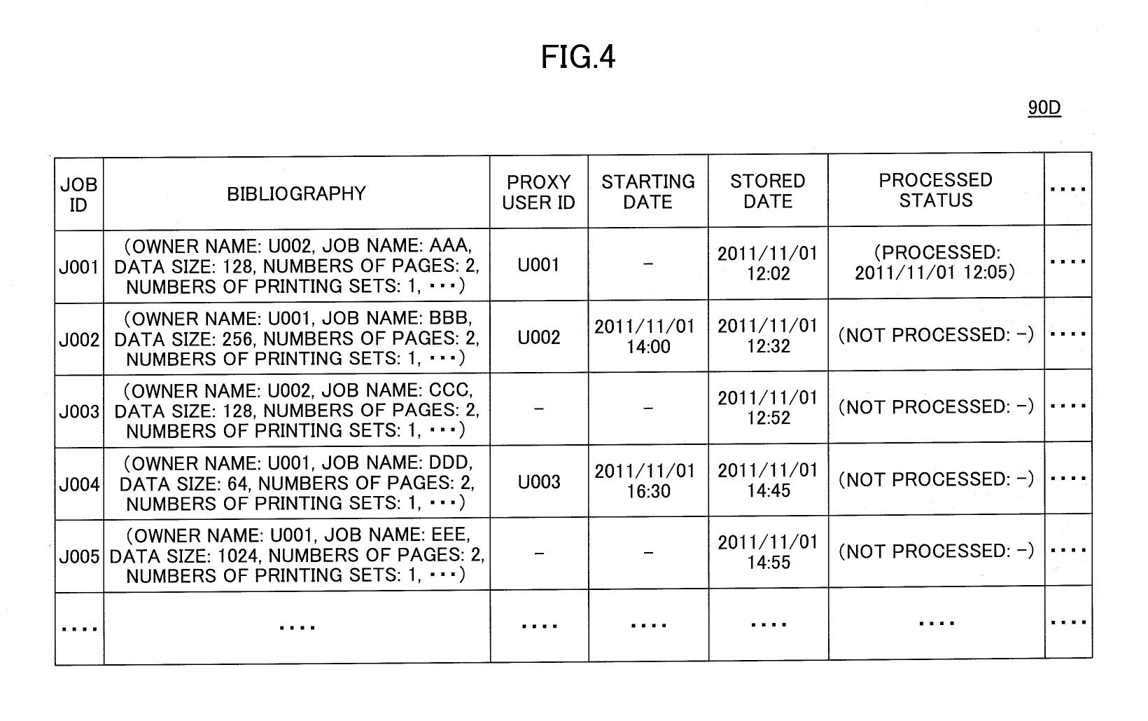

The job management unit 13 manages the job data. The job management unit 13 manages the job data based on the job management information that manages the job data. In this embodiment, the job management information storing unit 90 stores job management information 90D as shown in FIG. 4. The job management information storing unit 90 may be a predetermined storage area of the job control apparatus 100.

FIG. 4 is a view showing an example of the job management information 90D of the embodiment.

As shown in FIG. 4, the job management information 90D includes one or more data sets in each of which items such as the job ID, the bibliography, the appendix such as a proxy user (proxy user ID), the starting date or the like, the stored date, the processed status or the like are in correspondence with each other. The data set is prepared for each of the accepted job data.

The item “job ID” stores identification data of the stored job data such as the job ID as the item value. The job ID may be issued and recorded when the job data is stored.

The item “bibliography” stores a bibliography of the stored job data. The item values for the item “bibliography” may be an owner name (user ID of an owner of the stored job data), a job name, data size, the numbers of pages, the numbers of printing sets and the like. These item values are recorded based on the bibliography obtained by the data analyzing unit 12 as the analyzing result.

The item “proxy user” stores set data indicating a user capable of processing the stored job data in addition to the owner of the stored data. The item value for the item “proxy user” is recorded based on the appendix obtained by the analyzing unit 12 as the analyzing result.

The item “starting date” stores set data indicating the date from which the job data is to be processed upon the log-in of the user as a trigger. The item value for the “starting date” includes date and time of the starting date. The item value for the “starting date” is recorded based on the appendix obtained by the analyzing unit 12 as the analyzing result.

The item “stored date” stores information about the date when the job data is stored. The item value for the “stored date” includes date and time of the stored date. The item value for the “stored date” is recorded based on a value obtained from a clock circuit (not shown in the drawings) of the job control apparatus 100 when the job data is stored.

The item “processed status” stores information about a processed status of the stored job data. The item value for the “processed status” includes a status value (“processed”/“not processed”), processed date (date and time) and the like. The item value for the item “processed status” is set to be “not processed: -” as a default when the job data is stored and is changed to be the latest status “processed: 2011/11/01 12:05” when the processed result is sent from the image processing apparatus 200.

Although not shown in the drawings, the job management information 90D further includes information about a storage that stores the job data (for example, a data path, Uniform Resource Identifier (URI) or the like) for each of the stored job data. With this, in the job control apparatus 100, the job management information 90D is in correspondence with each of the stored job data sets.

Referring back to FIG. 3, the job management unit 13 manages the stored job data by accessing the job management information storing unit 90 and recording, deleting and obtaining the job management information 90D.

Upon receiving an analyzing result from the data analyzing unit 12, the job management unit 13 accesses the job management information storing unit 90 and generates a new data set. Then, the job management unit 13 stores the job data in a predetermined storage area, and records corresponding job management information 90D based on the received analyzing result.

Further, the job management unit 13 accesses the job management information storing unit 90 in accordance with a predetermined set schedule, specifies the job management information 90D the period for which from the stored date is over a predetermined period based on the stored date of the job management information 90D, and deletes the specified job management information 90D and the corresponding job data.

Further, upon accepting a request of obtaining the job list from the image processing apparatus 200 with the user ID of the log-in user, the job management unit 13 accesses the job management information storing unit 90, specifies the job management information 90D of the log-in user based on the user ID and obtains the specified job management information 90D of the log-in user.

Upon accepting a request of obtaining the job data from the image processing apparatus 200 with the job ID, the job management unit 13 accesses the job management information storing unit 90, specifies the storage that stores the job data based on the job ID, obtains the job data from the specified storage and sends the job data to the image processing apparatus 200.

The log-in accepting unit 14 accepts the log-in notice from the image processing apparatus 200. The log-in notice may include the user ID of the log-in user.

The job control unit 15 controls processing of the stored job data upon the log-in of the user as a trigger to the image processing apparatus 200.

When the log-in accepting unit 14 accepts the log-in notice, the job control unit 15 accesses the job management information storing unit 90 and specifies the job management information 90D of the log-in user based on the user ID of the log-in user accepted as the log-in notice.

At this time, the job control unit 15 specifies the job management information 90D of the owner name included in the item “bibliography” or the item “proxy user” which matches the user ID of the log-in user. It means that the job control unit 15 specifies the stored job data the owner of which or the set proxy user of which is the log-in user as candidate job data to be processed upon the log-in of the log-in user (hereinafter simply referred to as a “candidate job data”).

The determining unit 151 of the job control unit 15 determines whether to process the candidate job data processing based on the specified job management information 90D and the previously set predetermined condition that allows the stored job data to be processed by the image processing apparatus 200 upon the log-in of the user.

In other words, the job control unit 15 specifies the job management information 90D of the stored job data of the log-in user based on the user ID of the log-in user. Then, the job control unit 15 determines whether to process each of the stored job data sets of the log-in user based on the specified job management information 90D and the condition.

### (1) Previously Set Predetermined Condition

The determining unit 151 determines whether the job data is to be processed upon the log-in of the user based on the following conditions, for example. The determining unit 151 includes a storing unit that stores these conditions. The conditions are previously set by an administrator or the like based on an operation policy of the service.

### (1-1) Condition Based on Processed Status

The condition may be that “the job data is not processed yet”. This condition is referred to as a condition “JC1” in the following.

In this case, the determining unit 151 determines whether the candidate job data is already processed based on the information about the processed status of the job management information 90D (processed status value).

When the candidate job data is not processed yet, the job control unit 15 determines that the candidate job data to be processed. On the other hand, when the candidate job data is already processed, the job control unit 15 determines that the candidate job data is not to be processed.

### (1-2) Condition Based on Stored Period

When a user wishes to have the job data processed immediately after the user logs in, there is a high possibility that the user moves to the image processing apparatus 200 and logs in the image processing apparatus 200 immediately after the user sends the job data from the information terminal 300 to the job control apparatus 100 to be stored. Thus, the condition may be that “the stored period of the job data is within a predetermined period”. The “predetermined period” may also be stored in the storing unit of the determining unit 151. This condition is referred to as a condition “JC2” in the following.

In this case, the determining unit 151 obtains the date when the log-in notice is received (log-in date) and determines whether the stored period of the candidate job data is within the predetermined period based on the obtained log-in date and the stored date of the job management information 90D. The log-in date is obtained by a clock circuit (not shown in the drawings) of the job control apparatus 100 when the log-in notice is accepted.

When the stored period is within the predetermined period, the job control unit 15 determines that the candidate job data is to be processed. On the other hand, when the stored period is over the predetermined period, the job control unit 15 determines that the candidate job data is not to be processed.

### (1-3) Condition Based on Starting Date

The condition may be that “the log-in date is at or after the starting date of the job data”. This condition is referred to as a condition “JC3” in the following.

In this case, the determining unit 151 obtains the date when the log-in notice is received (log-in date) and determines whether the log-in date is at or after the starting date of the candidate job data based on the obtained log-in date and the starting date of the job management information 90D.

When the log-in date is at or after the starting date of the candidate job data, the job control unit 15 determines that the candidate job data is to be processed. On the other hand, when the log-in date is before the starting date of the candidate job data, the job control unit 15 determines that the candidate job data is not to be processed.

### (1-4) Condition Based on Data Size

In order to permit the stored job data to be processed upon the log-in of the user as a trigger, it is desirable that processing of the job data should be completed in a short time so that the usage of the image processing apparatus 200 is completed in the short time. Thus, it is desirable that the data size of the stored job data capable of being processed upon the log-in of the user is small. Thus, the condition may be that “the data size of the job data is less than or equal to a predetermined value”. The “predetermined value” may also be stored in the storing unit of the determining unit 151. This condition is referred to as a condition “JC4” in the following.

In this case, the determining unit 151 determines whether the data size of the candidate job data is less than or equal to the predetermined value based on the data size in the job management information 90D.

When the data size is less than or equal to the predetermined value, the job control unit 15 determines that the candidate job data is to be processed. On the other hand, when the data size is more than the predetermined value, the job control unit 15 determines that the candidate job data is not to be processed.

The determining unit 151 may store plural conditions and make the determination based on the plural conditions. In such a case, the conditions may be provided with priorities. Then, the determining unit 151 may determine whether the candidate job data is to be processed upon the log-in of the log-in user using the conditions in accordance with the priorities.

### (2) Specific Operation of Controlling Job Data

The job control unit 15 performs the following operation after determining whether the job data is to be processed.

### (2-1) When Job Data is Determined to be Processed

When the candidate job data is determined to be processed, the job control unit 15 obtains the job data based on the information about the storage and passes the obtained job data to the job sending unit 17 with a request to send the job data to the image processing apparatus 200. With this, the image processing apparatus 200 processes the received job data.

Thereafter, the job control unit 15 passes the user ID of the log-in user to the job list generating unit 16 with a request to generate a job list. With this, the job list of the log-in user is displayed at the image processing apparatus 200 after the job data is processed.

### (2-2) When Job Data is Determined not to be Processed

When the candidate job data is determined not to be processed, the job control unit 15 passes the user ID of the log-in user to the job list generating unit 16 and includes an instruction to generate a job list for the log-in user. With this, the job list of the log-in user is displayed at the image processing apparatus 200 after the user logs in.

As described above, in the image processing apparatus 200, the job list of the log-in user is displayed after the job data is processed or after the log-in of the user in accordance with the request from the job control apparatus 100.

The job list generating unit 16 generates a job list of the log-in user. Upon receiving a request of generating a job list from the job control unit 15, the job list generating unit 16 outputs the user ID to the job management unit 13 and requests to obtain the job management information 90D of the log-in user. When the job management information 90D is obtained from the job management unit 13, the job list generating unit 16 generates the job list based on the obtained job management information 90D. The job list generating unit 16 sends the generated job list to the job obtaining unit 22 of the image processing apparatus 200 to request displaying the job list.

The job sending unit 17 sends the job data to the job processing unit 23 of the image processing apparatus 200. Upon receiving a request to send the job data from the job control unit 15, the job sending unit 17 sends the job data to the image processing apparatus 200 with a request to process the job data.

Upon receiving a processed result response from the image processing apparatus 200, the job sending unit 17 outputs the processed result response to the job control unit 15 to update the processed status of the job management information 90D.

As described above, the job control function of the embodiment is performed by a combination of the components. Further, the above functional components are actualized when arithmetic units (CPUs) read programs installed in the apparatuses or devices composing the print control system 1 from the storage devices (HDDs or ROMs) or the memories (RAMs), respectively.

The operation of the job control function of the embodiment is explained in detail with reference to a sequence diagram and a flowchart. In the following, a basic operation of controlling processing of the job data is explained first, and the operation of determining whether the candidate job data is to be processed is explained in detail thereafter.

### (Job Control Process)

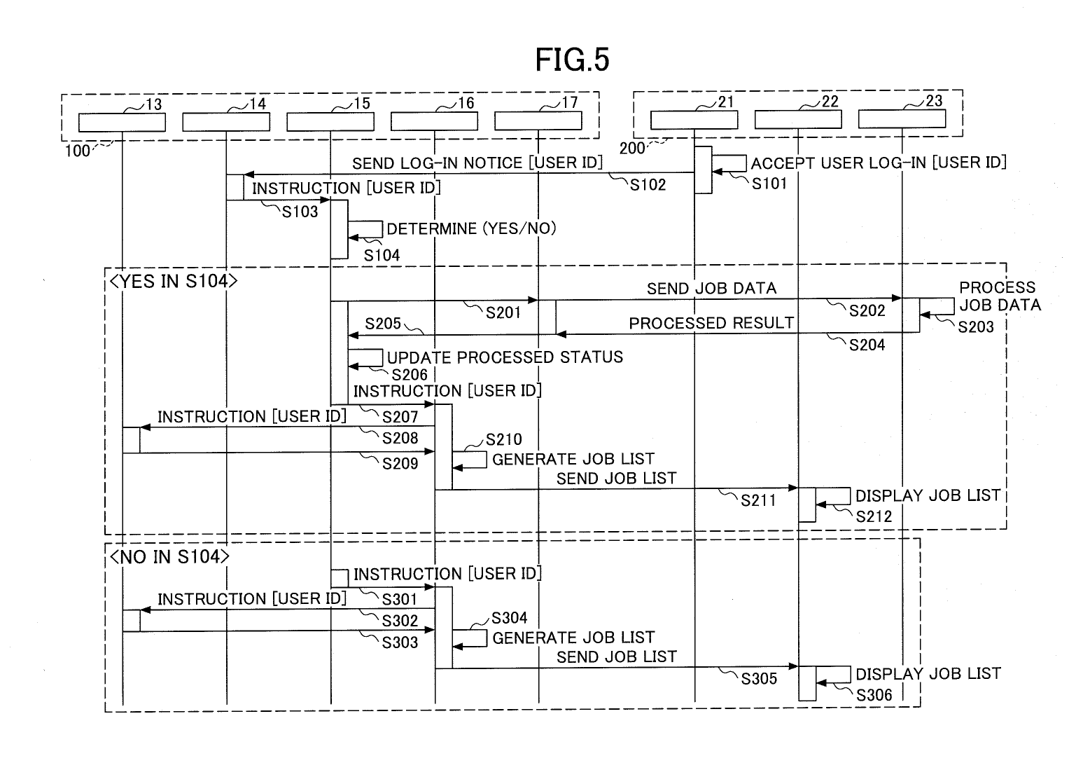

FIG. 5 is a sequence diagram showing an example of a job control process of the embodiment. For the processes shown in FIG. 5, it is assumed that the job data is already stored in the job control apparatus 100. Thus, an operation after the image processing apparatus 200 accepts a log-in of a user is explained.

In the image processing apparatus 200, the log-in control unit 21 accepts a user log-in (step S101). At this time, the log-in control unit 21 performs a user authentication based on the authentication data of the user, and obtains the user ID of the log-in user.

When the user is authenticated, the log-in control unit 21 sends the log-in notice to the log-in accepting unit 14 of the job control apparatus 100 (step S102). At this time, the log-in control unit 21 sends the user ID of the log-in user to the log-in accepting unit 14 of the job control apparatus 100.

Upon receiving the user ID from the log-in control unit 21, in the job control apparatus 100, the log-in accepting unit 14 instructs the job control unit 15 to determine whether the job data of the log-in user is to be processed (step S103). At this time, the log-in accepting unit 14 outputs the user ID of the log-in user received with the log-in notice to the job control unit 15.

Upon receiving the instruction from the log-in accepting unit 14, the job control unit 15 determines whether to process the job data of the log-in user based on the condition (step S104). At this time, the job control unit 15 accesses the job management information storing unit 90 and specifies the candidate job data of the log-in user based on the user ID of the log-in user and the job management information 90D. Then, the determining unit 151 of the job control unit 15 determines whether each of the candidate job data is to be processed based on the specified job management information 90D and the set condition. This operation of step S104 will be explained later in detail.

When the candidate job data is to be processed (YES), the job control unit 15 instructs the job sending unit 17 to send the job data that satisfies the condition (step S201). At this time, the job control unit 15 obtains the job data which is determined to be processed based on the information about the storage of the job data and outputs the obtained job data to the job sending unit 17.

Upon receiving the instruction from the job control unit 15, the job sending unit 17 sends the job data to the job processing unit 23 of the image processing apparatus 200 with a request to process the job data (step S202).

Then, in the image processing apparatus 200, the job processing unit 23 processes (prints) the received job data (step S203). Thereafter, the job processing unit 23 sends a processed result of the job data to the job sending unit 17 of the job control apparatus 100 as a response (step S204).

Upon receiving the processed result, in the job control apparatus 100, the job sending unit 17 instructs the job control unit 15 to update the processed status of the job data based on the received processed result (step S205). At this time, the job sending unit 17 outputs the processed result to the job control unit 15.

Upon receiving the instruction from the job sending unit 17, the job control unit 15 updates the information about the processed status of the job management information 90D based on the received processed result (step S206). At this time, the job control unit 15 accesses the job management information storing unit 90 and specifies the job management information 90D of the job data based on the job ID included in the processed result. Then, the job control unit 15 updates the information about the processed status of the specified job management information 90D.

Subsequently, the job control unit 15 instructs the job list generating unit 16 to generate the job list of the log-in user (step S207). At this time, the job control unit 15 outputs the user ID of the log-in user to the job list generating unit 16.

Upon receiving the instruction from the job control unit 15, the job list generating unit 16 instructs the job management unit 13 to obtain the job management information 90D of the log-in user (step S208). At this time, the job list generating unit 16 outputs the user ID of the log-in user to the job management unit 13.

Upon receiving the instruction from the job list generating unit 16, the job management unit 13 obtains the job management information 90D of the log-in user and outputs the obtained data to the job list generating unit 16 (step S209). At this time, the job management unit 13 accesses the job management information storing unit 90 and specifies the job management information 90D of the log-in user based on the user ID of the log-in user.

The job list generating unit 16 generates the job list based on the received job management information 90D (step S210), and sends the generated job list to the job obtaining unit 22 of the image processing apparatus 200 with a request to display the job list (step S211).

Upon receiving the job list, in the image processing apparatus 200, the display unit 221 of the job obtaining unit 22 displays the job list on the operations panel (step S212).

On the other hand, when the job control unit 15 determines that the candidate job data is not to be processed in step S104, the job control unit 15 instructs the job list generating unit 16 to generate the job list of the log-in user (step S301). At this time, the job control unit 15 outputs the user ID of the log-in user to the job list generating unit 16.

Upon receiving the instruction from the job control unit 15, the job list generating unit 16 instructs the job management unit 13 to obtain the job management information 90D of the log-in user (step S302). At this time, the job list generating unit 16 outputs the user ID of the log-in user to the job management unit 13.

Upon receiving the instruction from the job list generating unit 16, the job management unit 13 obtains the job management information 90D of the log-in user and outputs the obtained information to the job list generating unit 16 (step S303). At this time, the job management unit 13 accesses the job management information storing unit 90 and specifies the job management information 90D of the log-in user based on the user ID of the log-in user.

The job list generating unit 16 generates the job list based on the received job management information 90D (step S304), and sends the generated job list to the job obtaining unit 22 of the image processing apparatus 200 with a request to display the job list (step S305).

Upon receiving the job list, in the image processing apparatus 200, the display unit 221 of the job obtaining unit 22 displays the job list on the operations panel (step S306).

With this, according to the job control system 1 of the embodiment, the user can obtain the processed result of own job data at the facing image processing apparatus 200 with a simple operation.

The operation of step S104 is explained in detail.

### Determining Whether to Process Job Data

### Example 1

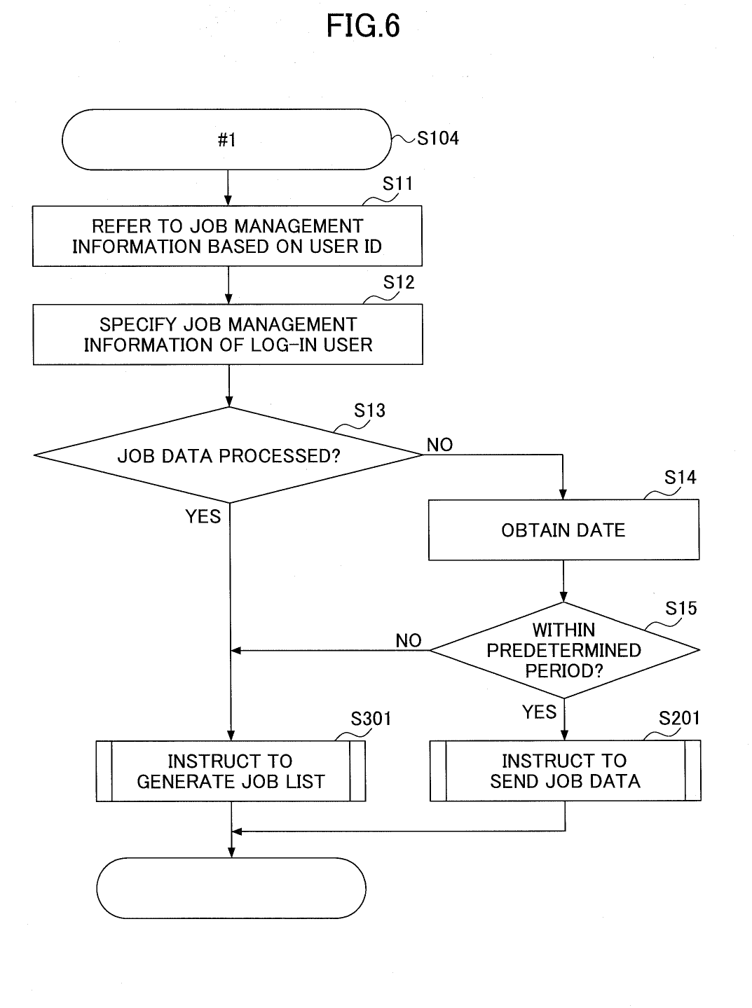

FIG. 6 is a flowchart showing an example of an operation of determining whether to process the job data. In this example, it is assumed that the condition “JC1” that the “the job data is not processed yet” and the condition “JC2” that “the stored period of the job data is within a predetermined period” are stored as the conditions in determining unit 151 with the priority of this order. Thus, FIG. 6 shows an example where whether the job data is to be processed is determined based on the processed status and the stored period of the stored job data.

First, whether the candidate job data of the log-in user is already processed is determined.

As shown in FIG. 6, the job control unit 15 refers to the job management information 90D of the job management information storing unit 90 based on the user ID of the log-in user (step S11) and specifies the job management information 90D of the log-in user (step S12). With this, the job control unit 15 specifies the candidate job data of the log-in user including the proxy user.

Subsequently, the determining unit 151 of the job control unit 15 determines whether the specified candidate job data is already processed (step S13). At this time, the determining unit 151 determines whether the specified candidate job data is already processed based on the specified information about the processed status of the job management information 90D (processed status value).

When the determining unit 151 determines that the candidate job data is not processed yet (step S13: NO), the process moves to determine whether the stored period of the candidate job data of the log-in user is within the predetermined period.

The determining unit 151 obtains the date when the log-in notice is received by the clock circuit (not shown in the drawings) of the job control apparatus 100, and obtains the stored date of the stored data from the job management information 90D of the candidate job data (step S14).

The determining unit 151 determines whether the stored period of the candidate job data is within the predetermined period based on the obtained date and the stored date (step S15).

When the stored period is determined to be within the predetermined period (step S15: YES), the determining unit 151 determines to process the job data and instructs the job sending unit 17 to send the job data (step S201). Thus, the job control apparatus 100 sends the request of processing the job data to the image processing apparatus 200 upon the log-in of the user.

On the other hand, when the stored period is determined to be over the predetermined period (step S15: NO), the determining unit 151 determines not to process the job data and instructs the job list generating unit 16 to generate the job list of the log-in user (step S301). Thus, the job control apparatus 100 sends a request to display the job list to the image processing apparatus 200 upon the log-in of the user.

When the candidate job data is determined to be already processed (step S13: YES), the process proceeds to step S301.

As described above, in this example, the stored job data of the log-in user which is not processed yet and the stored period of which is within the predetermined period among the stored job data sets of the log-in user is controlled to be processed upon the log-in of the user as a trigger.

### Determining Whether to Process Job Data

### Example 2

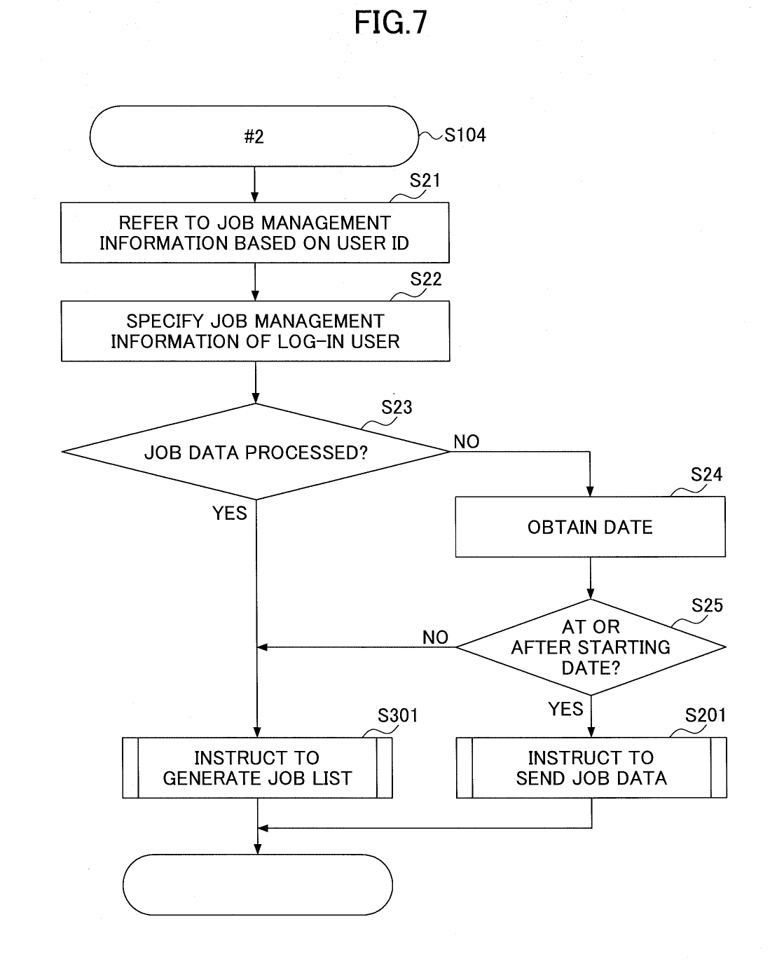

FIG. 7 is a flowchart showing another example of an operation of determining whether to process the job data. In this example, it is assumed that the condition “JC1” that the “the job data is not processed yet” and the condition “JC3” that “the log-in date is at or after the starting date of the job data” are stored as the conditions in the determining unit 151 with the priority of this order. Thus, FIG. 7 shows an example where whether the job data is to be processed is determined based on the processed status and the starting date of the stored job data.

First, whether the candidate job data of the log-in user is already processed is determined.

As shown in FIG. 7, the job control unit 15 refers to the job management information 90D of the job management information storing unit 90 based on the user ID of the log-in user (step S21), and specifies the job management information 90D of the log-in user (step S22). With this, the job control unit 15 specifies the candidate job data of the log-in user including a proxy user.

Subsequently, the determining unit 151 of the job control unit 15 determines whether the specified candidate job data is already processed (step S23). At this time, the determining unit 151 determines whether the specified candidate job data is already processed based on the specified information about the processed status of the job management information 90D (processed status value).

When the determining unit 151 determines that the candidate job data is not processed yet (step S23: NO), the process moves to determine whether the log-in date is at or after the starting date of the job data.

The determining unit 151 obtains the date when the log-in notice is received by the clock circuit (not shown in the drawings) of the job control apparatus 100, and obtains the starting date of the stored data from the job management information 90D of the candidate job data (step S24).

The determining unit 151 determines whether the log-in date of the candidate job data is at or after the starting date based on the obtained date and the stored date (step S25).

When the log-in date is determined to be at or after the starting date (step S25: YES), the determining unit 151 determines to process the job data and instructs the job sending unit 17 to send the job data (step S201). Thus, the job control apparatus 100 sends the request to process the job data to the image processing apparatus 200 upon the log-in of the user.

On the other hand, when the log-in date is determined to be before the starting date (step S25: NO), the determining unit 151 determines not to process the job data and instructs the job list generating unit 16 to generate the job list of the log-in user (step S301). Thus, the job control apparatus 100 sends a request to display the job list to the image processing apparatus 200 upon the log-in of the user.

When the candidate job data is determined to be already processed (step S23: YES), the process proceeds to step S301.

As described above, in this example, the stored job data of the log-in user which is not processed yet and for which the log-in date is at or after the starting date, among the stored job data sets of the log-in data, is controlled to be processed upon log-in of the user as a trigger.

### Determining Whether to Process Job Data

### Example 3

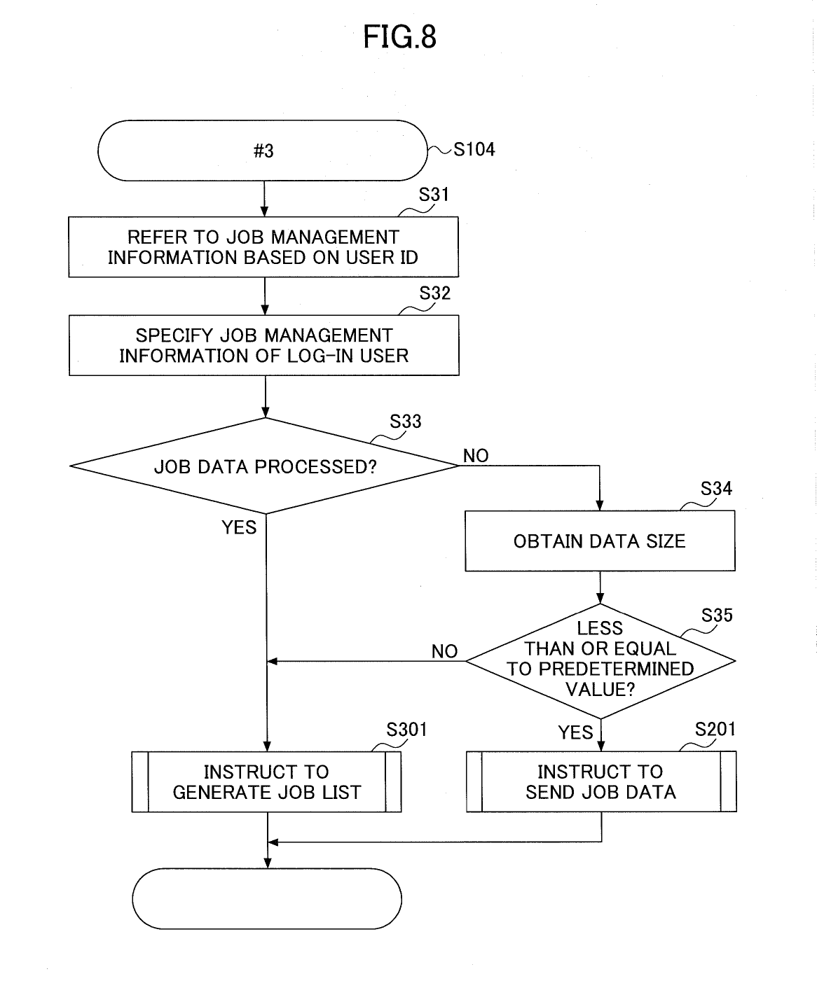

FIG. 8 is a flowchart showing another example of an operation of determining whether to process the job data. In this example, it is assumed that the condition “JC1” that the “the job data is not processed yet” and the condition “JC4” that “the data size of the job data is less than or equal to a predetermined value” are stored as the conditions in the determining unit 151 with the priority of this order. Thus, FIG. 8 shows an example where whether the job data is to be processed is determined based on the processed status and the data size of the stored job data.

First, whether the candidate job data of the log-in user is already processed is determined.

As shown in FIG. 8, the job control unit 15 refers to the job management information 90D of the job management information storing unit 90 based on the user ID of the log-in user (step S31), and specifies the job management information 90D of the log-in user (step S32). With this, the job control unit 15 specifies the candidate job data of the log-in user including a proxy user.

Subsequently, the determining unit 151 of the job control unit 15 determines whether the specified candidate job data is already processed (step S33). At this time, the determining unit 151 determines whether the specified candidate job data is already processed based on the specified information about the processed status of the job management information 90D (processed status value).

When the determining unit 151 determines that the candidate job data is not processed (step S33: NO), the process moves to determine whether the data size of the job data is less than or equal to the predetermined value.

The determining unit 151 obtains the data size of the candidate job data included in the bibliography of the job management information 90D of the candidate job data (step S34).

The determining unit 151 determines whether the data size of the candidate job data is less than or equal to the predetermined value based on the obtained data size (step S35).

When the data size is determined to be less than or equal to the predetermined value (step S35: YES), the determining unit 151 determines to process the job data and instructs the job sending unit 17 to send the job data (step S201). Thus, the job control apparatus 100 sends the request of processing the job data to the image processing apparatus 200 upon the log-in of the user.

On the other hand, when the data size is determined to be more than the predetermined value (step S35: NO), the determining unit 151 determines not to process the job data and instructs the job list generating unit 16 to generate the job list of the log-in user (step S301). Thus, the job control apparatus 100 sends a request to display the job list to the image processing apparatus 200 upon the log-in of the user.

When the candidate job data is determined to be already processed (step S33: YES), the process proceeds to step S301.

As described above, in this example, the stored job data of the log-in user which is not processed yet and the data size of which is less than or equal to the predetermined value among the stored job data sets of the log-in data is controlled to be processed upon log-in of the user as a trigger.

In this embodiment, as described above, the job data to be processed upon the log-in of the user as a trigger is determined based on the previously set predetermined conditions.

As described above, according to the job control apparatus 100 of the embodiment, when the log-in accepting unit 14 accepts the log-in notice of the user from the image processing apparatus 200, the job control unit 15 specifies the job management information of the log-in user among the job management information sets that manages the stored job data. The job control apparatus 100 determines whether to process the job data of the log-in user based on the job management information specified by the determining unit 151 and the conditions. Then, the job sending unit 16 sends the job data that satisfies the conditions to the image processing apparatus 200 based on the determined result by the determining unit 115 and requests the image processing apparatus 200 to process the job data.

According to the job control system 1 of the embodiment, the user can have the facing image processing apparatus 200 process the job data with a simple operation and obtain the processed result. As a result, according to the job control system 1 of the embodiment, convenience for the user can be improved while ensuring the security of the output result when processing the job data.

### Alternative Example

Although whether to process the job data upon the log-in of the user as a trigger is determined based on the condition set in accordance with the system operation policy in the above embodiment, this is not limited so.

In this example, whether to process the job data is determined in accordance with a condition set for each of the log-in users. It is to be noted that, in the explanation of the drawings, the same components are given the same reference numerals, and explanations are not repeated.

### Job Control Function

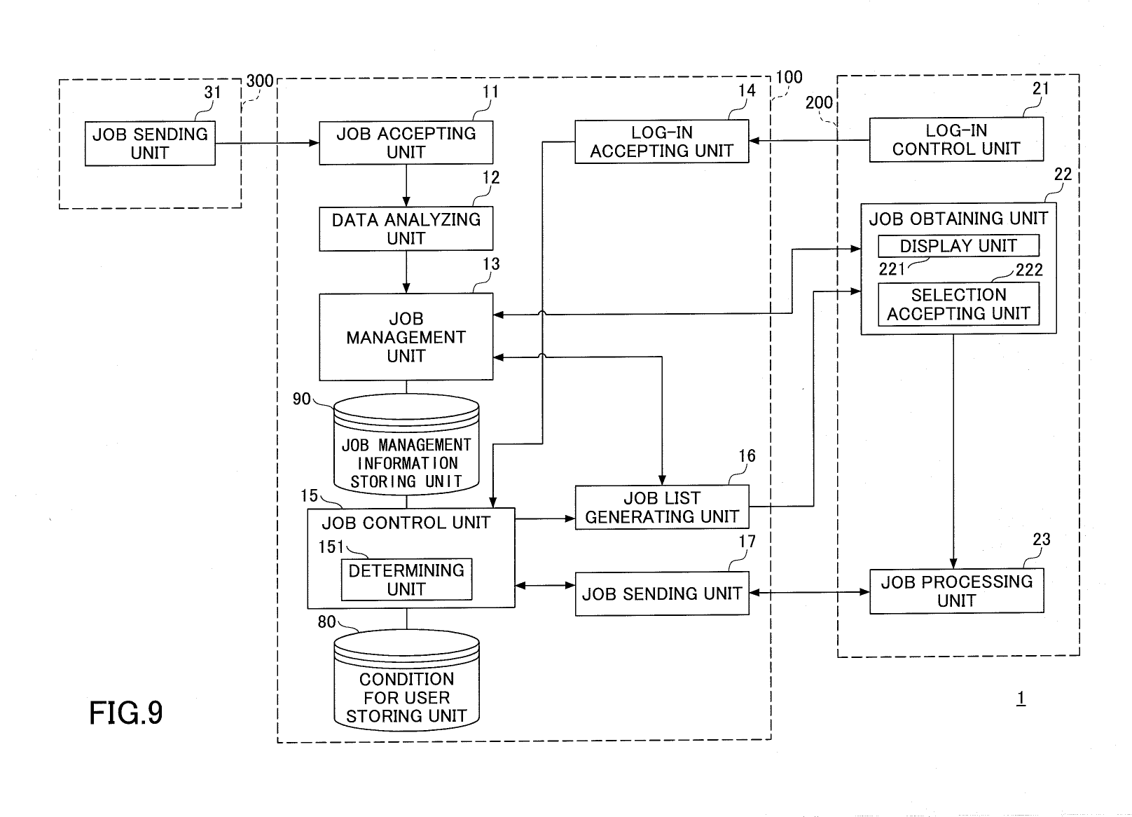

FIG. 9 is a block diagram showing another example of the job control function.

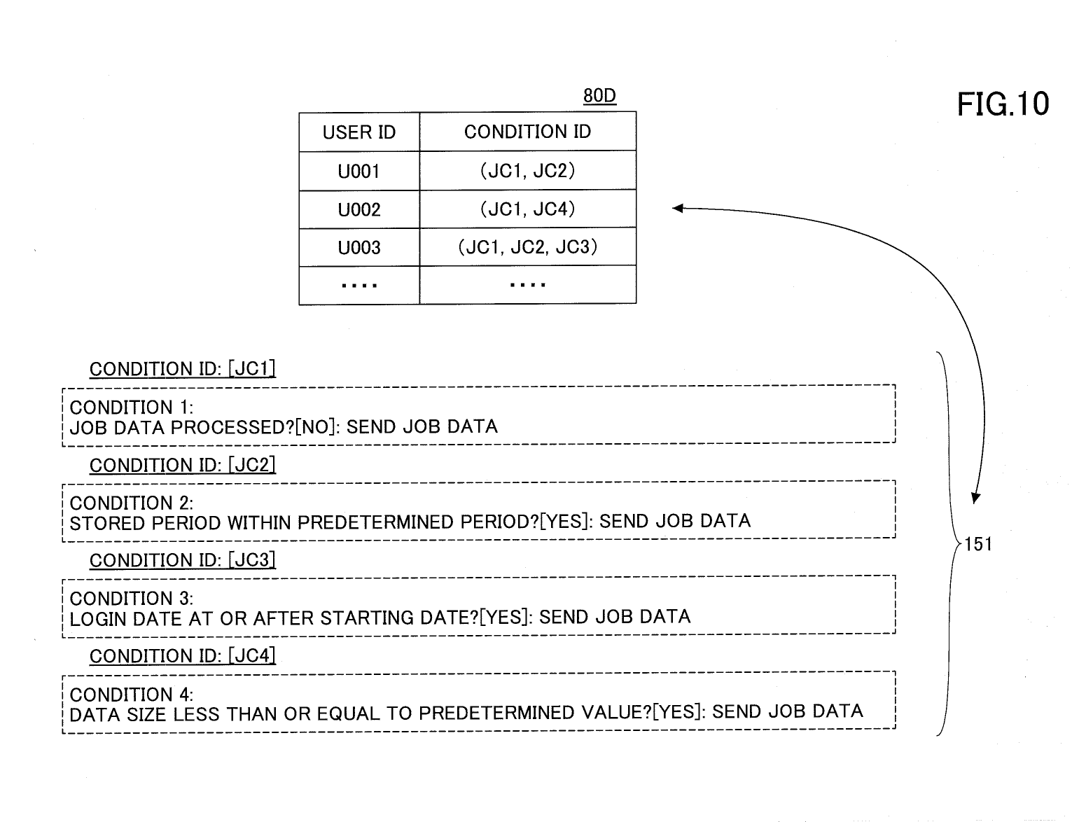

As shown in FIG. 9, in this example, the job control apparatus 100 further includes a condition for user storing unit 80. The condition for user storing unit 80 is a predetermined storage area of the job control apparatus 100 and stores a previously set predetermined condition for user which is used when determining whether to process the job data as shown in FIG. 10.

FIG. 10 is a view showing an example of the condition for user 80D.

As shown in FIG. 10, the condition for user 80D includes one or more data sets in which items such as the user ID, the condition ID and the like are in correspondence with each other. The data set is prepared for each of the users.

The item “user ID” stores identification data of the user. The item “condition ID” stores identification data of the condition. The condition IDs of the previously set plural conditions (four conditions “JC1” to “JC4” in FIG. 10) may be stored as the item values of the item “condition ID”.

These item values may be set by an administrator or the like based on an operation policy of the service. The conditions are stored in the storing unit of the determining unit 151 as explained above in correspondence with the condition IDs. At this time, each of the conditions identified by the condition ID is used in determining whether to process the job data specified based on the respective user ID.

Plural of the condition IDs may be set for each of the user IDs.

Referring back to FIG. 9, the job control unit 15 specifies the condition to be used in determining whether to process the job data of the log-in user based on the condition for user 80D, and determines whether to process the job data in accordance with the specified condition. The job control unit 15 of the example performs the following operation.

When the log-in accepting unit 14 accepts the log-in notice, the job control unit 15 accesses the condition for user storing unit 80 and specifies the condition for user 80D of the log-in user based on the user ID of the log-in user accepted as the log-in notice. At this time, the job control unit 15 specifies the condition for user 80D, the user ID of which matches the user ID of the log-in user. The job control unit 15 specifies the condition to be used in determining whether the job data of the log-in user is to be processed based on the condition ID of the specified condition for user 80D.

Then, the job control unit 15 accesses the job management information storing unit 90, and specifies the job management information 90D of the log-in user based on the user ID of the log-in user accepted as the log-in notice.

The determining unit 151 of the job control unit 15 determines whether to process the job data based on the specified job management information 90D and the specified condition. It means that the job control unit 15 specifies the condition to be used and the candidate job data based on the user ID of the log-in user, and determines whether to process each of the stored job data sets of the log-in user based on the specified job management information 90D and the condition.

As described above, the job control function of the example is performed by the job control unit 15. The job control function of the example is explained in detail with reference to a flowchart.

### Determining Whether to Process Job Data

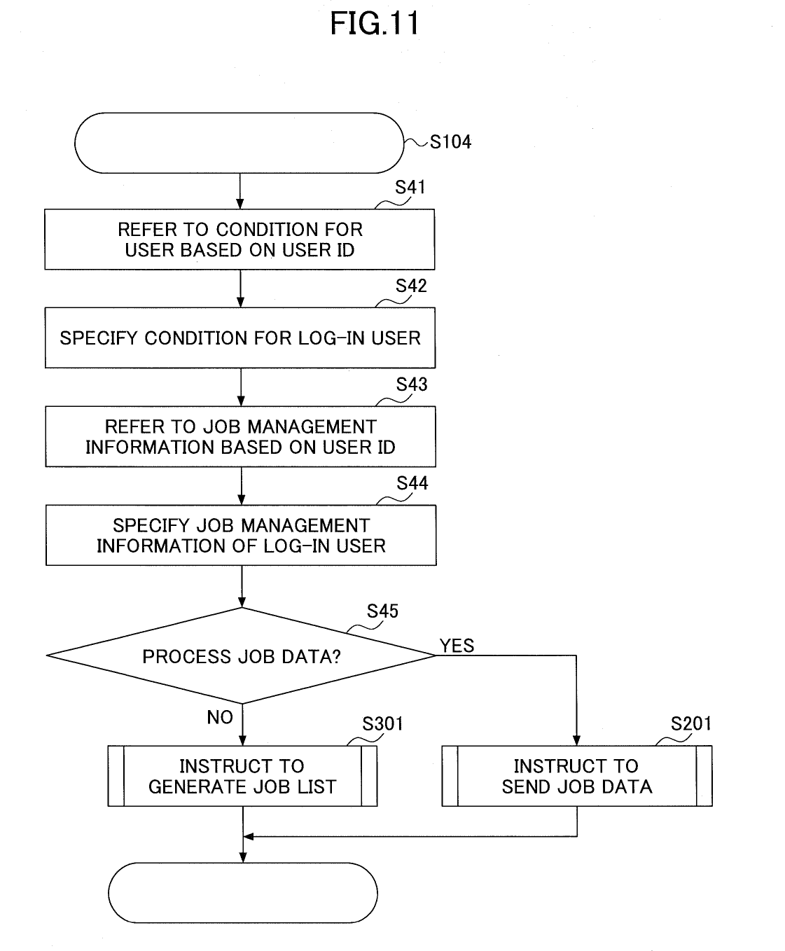

FIG. 11 is a flowchart showing an example of an operation of determining whether to process the job data. FIG. 11 shows an example where whether the job data is to be processed is determined based on the condition set for the log-in user.

As shown in FIG. 11, the job control unit 15 accesses the condition for user storing unit 80, refers to the condition for user 80D of the log-in user based on the user ID of the log-in user (step S41), and specifies the condition for user 80D of the log-in user (step S42). Thus, in the job control apparatus 100, the condition to be used in determining whether to process the job data is specified based on the condition ID in the specified condition for user 80D among the plural conditions.

Then, the job control unit 15 refers to the job management information 90D of the job management information storing unit 90 based on the user ID of the log-in user (step S43), and specifies the job management information 90D of the log-in user (step S44). With this, the job control unit 15 specifies the candidate job data of the log-in user including a proxy user.

Subsequently, the determining unit 151 of the job control unit 15 determines whether the specified condition is satisfied for the specified candidate job data (step S45). At this time, the determining unit 151 obtains a parameter to use in determining whether the job data is to be processed from the job management information 90D, and determines whether to process the job data based on the obtained parameter and the condition.

When the determining unit 151 determines that the candidate job data is to be processed (step S45: YES), the job control unit 15 instructs the job sending unit 17 to send the job data (step S201). Thus, the job control apparatus 100 sends the request of processing the job data to the image processing apparatus 200 upon the log-in of the user.

On the other hand, when the determining unit 151 determines not to process the job data (step S45: NO), the job control unit 15 instructs the job list generating unit 16 to generate the job list of the log-in user (step S301). Thus, the job control apparatus 100 sends a request to display the job list to the image processing apparatus 200 upon the log-in of the user.

As described above, when plural of the condition IDs are in correspondence with the user ID of the log-in user, the determining unit 151 performs plural determinations as explained above with reference to FIG. 6 to FIG. 8. The determining unit 151 determines whether the candidate job data is to be processed upon the log-in of the log-in user using the conditions in accordance with the priority.

According to the job control system 1 of the example, whether to process the job data upon the log-in of the user as a trigger can be determined based on the condition set for the user. Thus, according to the job control system 1 of the example, a more flexible service can be provided where convenience for the user can be improved while ensuring the security of the output result when processing the job data for each of the users as well as obtaining the same merit as the above embodiment.

### Alternative Example 2

Although the job data is automatically processed by the image processing apparatus 200 when the job data is determined to be processed upon the log-in of the user in the above embodiment, this is not limited so.

In this example, the user is capable of determining whether to process the job data which is determined to be processed upon the log-in of the user by the job control apparatus 100. It is to be noted that, in the explanation of the drawings, the same components are given the same reference numerals, and explanations are not repeated.

### Job Control Function

When the determining unit 151 determines to process the candidate job data, the job control unit 15 sends the job management information 90D of the job data to the log-in control unit 21 of the image processing apparatus 200 with a request to display an accepting display capable of accepting an instruction from the log-in user. With this, in the image processing apparatus 200, the accepting display is displayed on the operations panel.

Upon accepting an instruction from the log-in user indicating whether to process the job data, the log-in control unit 21 sends the accepted result (to be processed/not to be processed) to the job control unit 15 of the job control apparatus 100. With this, the job control apparatus 100 controls whether to process the job data based on the received result.

As described above, the job control function of the example is performed by a combination of the components.

The operation of the job control function of the example is explained with reference to a sequence diagram in detail.

### Job Control Process

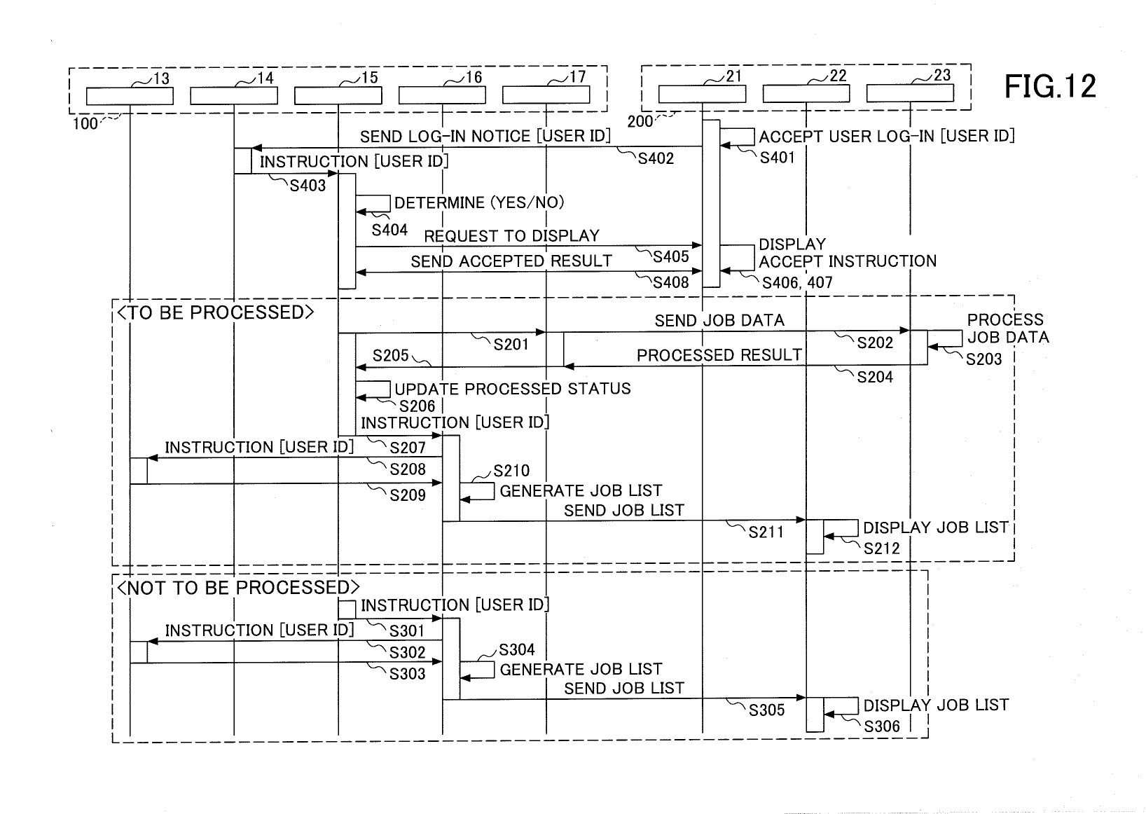

FIG. 12 is a sequence diagram showing an example of a job control process of the example.

As shown in FIG. 12, in the image processing apparatus 200, the log-in control unit 21 accepts a user log-in (step S401). At this time, the log-in control unit 21 performs a user authentication based on the authentication data of the user, and obtains the user ID of the log-in user.

When the user is authenticated, the log-in control unit 21 sends the log-in notice to the log-in accepting unit 14 of the job control apparatus 100 (step S402). At this time, the log-in control unit 21 sends the user ID of the log-in user to the log-in accepting unit 14 of the job control apparatus 100.

Upon receiving the user ID from the log-in control unit 21, in the job control apparatus 100, the log-in accepting unit 14 instructs the job control unit 15 to determine whether the job data of the log-in user is to be processed (step S403). At this time, the log-in accepting unit 14 outputs the user ID of the log-in user received with the log-in notice to the job control unit 15.

Upon receiving the instruction from the log-in accepting unit 14, the job control unit 15 determines whether to process the job data of the log-in user based on the condition (step S404). At this time, the job control unit 15 accesses the job management information storing unit 90 and specifies the candidate job data of the log-in user based on the user ID of the log-in user and the job management information 90D. Then, the determining unit 151 of the job control unit 15 determines whether each of the candidate job data sets is to be processed based on the specified job management information 90D.

When the candidate job data is to be processed, the job control unit 15 sends information about the job data (that satisfies the condition) to the log-in control unit 21 of the image processing apparatus 200 with a request to display an accepting display capable of accepting an instruction whether to process the job data from the log-in user (step S405). At this time, the job control unit 15 sends the job management information 90D of the job data which is determined to be processed as the information to the image processing apparatus 200.

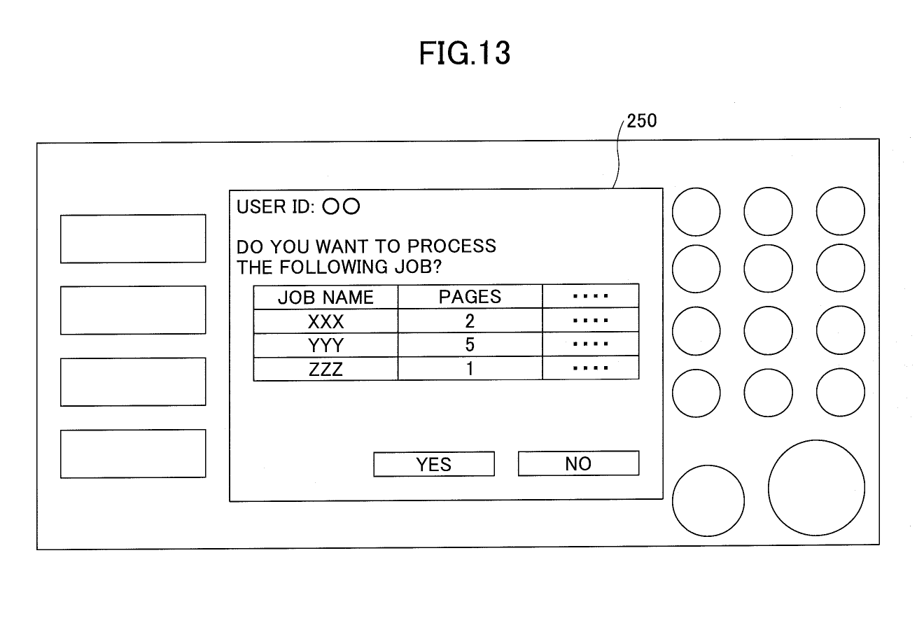

Upon receiving the request, in the image processing apparatus 200, the log-in control unit 21 displays the accepting display capable of accepting an instruction whether to process the job data as shown in FIG. 13 (step S406).

FIG. 13 is an example of an accepting display 250 displayed on the operations panel of the image processing apparatus 200.

The accepting display 250 shown in FIG. 13 includes the information about the job data of the log-in user (for example, the job name, the numbers of pages or the like) and a Graphical User Interface (GUI) by which the log-in user can select whether to process the job data. The log-in control unit 21 generates the accepting display 250 based on the job management information 90D received with the request to display the accepting display and displays it on the operations panel.

Referring back to FIG. 12, the log-in control unit 21 accepts an instruction from the log-in user via the accepting display (step S407), and sends the accepted result to the job control unit 15 of the job control apparatus 100 (step S408).

Upon receiving the result, the job control unit 15 of the job control apparatus 100 controls whether to process the job data based on the log-in of the log-in user. When the result received from the log-in control unit 21 is “to be processed”, the job control unit 15 proceeds to the process of step S201. On the other hand, when the result received from the log-in control unit 21 is “not to be processed”, the job control unit 15 proceeds to the process of step S301.

When it is determined that the job data is not to be processed in step S404, the processes of step S405 to S408 are skipped and the job control unit 15 proceeds to the process of step S301.

Thus, in this example, when the candidate job data is determined to be processed by the job control apparatus 100, an environment in which the log-in user is capable of determining whether to process the job data by the log-in of the log-in user is provided.

Thus, according to the job control system 1 of the example, a more flexible service can be provided where whether the job data is to be processed upon the log-in of the user can be determined by the log-in user as well as obtaining the same merit as the above embodiment.

### Alternative Example 3

As described in the above embodiment, when “the job data is not processed yet” (JC1) is set as the condition to determine whether to process the job data upon the log-in of the user as a trigger, the job data which is already processed once cannot be processed upon the log-in of the user. Thus, if the user hopes to have the stored job data which was already processed once be processed again, the user needs to perform the troublesome methods at the image processing apparatus 200.

It may be preferable to process the job data upon the log-in of the user as a trigger even if the job data is already processed when the same user continuously logs into the image processing apparatus 200.

Specifically, a situation as follows may be assumed. An organizer of a meeting logs into the image processing apparatus 200 which is placed in a meeting room to obtain printed documents of stored job data for participants of the meeting. The organizer is capable of obtaining the printed documents by logging into the image processing apparatus 200 according to the job control function of the job control system 1 of the embodiment. Then, if a new participant appears, the organizer needs to print the printed document of the stored job data for the new participant. At this time, the organizer hopes to obtain the printed document just by logging into the image processing apparatus 200.

Thus, in this example, the following technique is provided for a case when the same user continuously logs into the image processing apparatus 200. It is to be noted that, in the explanation of the drawings, the same components are given the same reference numerals, and explanations are not repeated.

### Job Control Function

Continuous log-in by the same user may be detected at the image processing apparatus 200, or at the job control apparatus 100.

### Detection at Image Processing Apparatus 200

In this example, the log-in control unit 21 of the image processing apparatus 200 detects the continuous log-in by the same user by determining whether the current log-in user is the same as the previous log-in user. For example, it is assumed that a history of a user log-in is stored in a predetermined storage area of the image processing apparatus 200 as a log-in history (as a cache). The log-in history may be the user ID of the log-in user recorded in the authenticated order.

The log-in control unit 21 compares the current user ID of the log-in user and the previous user ID of the log-in user recorded in the log-in history (cash data), and determines whether the log-in users are the same. When the log-in users are the same, the log-in control unit 21 sends a continuous log-in detected result indicating that the current log-in user is the same as the previous one with the log-in notice to the log-in accepting unit 14 of the job control apparatus 100.

When the log-in accepting unit 14 accepts the log-in notice and the continuous log-in detected result from the log-in control unit 21 of the image processing apparatus 200, the job control unit 15 receives the continuous log-in detected result and the user ID of the log-in user from the log-in accepting unit 14, and determines whether to process the job data of the log-in user. At this time, the job control unit 15 determines to process the job data even when the candidate job data is already processed, based on the continuous log-in detected result.

### Detection at Job Control Apparatus 100

When the log-in accepting unit 14 accepts the log-in notice from the log-in control unit 21 of the image processing apparatus 200, the log-in control unit 15 receives the user ID of the log-in user received with the log-in notice from the log-in accepting unit 14 and detects the continuous log-in of the log-in user. At this time, the log-in control unit 15 accesses the job management information storing unit 90, and specifies the job management information 90D of the log-in user based on the user ID of the log-in user. Then, the log-in control unit 15 specifies the latest information about the processed status (information indicating the latest processed date) based on the specified information about the processed status of the job management information 90D. Then, the log-in control unit 15 determines whether the period from the latest processed date is within the predetermined period based on the specified information about the processed status. The predetermined period may be set by an administrator or the like based on an operation policy of the service.

When the period from the latest processed date is within the predetermined period, the job control unit 15 detects the continuous log-in by the same user. On the other hand, when the period from the latest processed date is over the predetermined period, the job control unit 15 does not detect the continuous log-in by the same user.

In this example, the job control unit 15 performs the detection of the continuous log-in by the same user before determining whether the job data is to be processed. Then, when the continuous log-in by the same user is detected, even if the candidate job data is already processed, the job control unit 15 determines to process the job data again.

As described above, the job control function of the example is performed by a combination of the components.

The operation of the job control function of the example is explained in detail with reference to sequence diagrams and flowcharts.

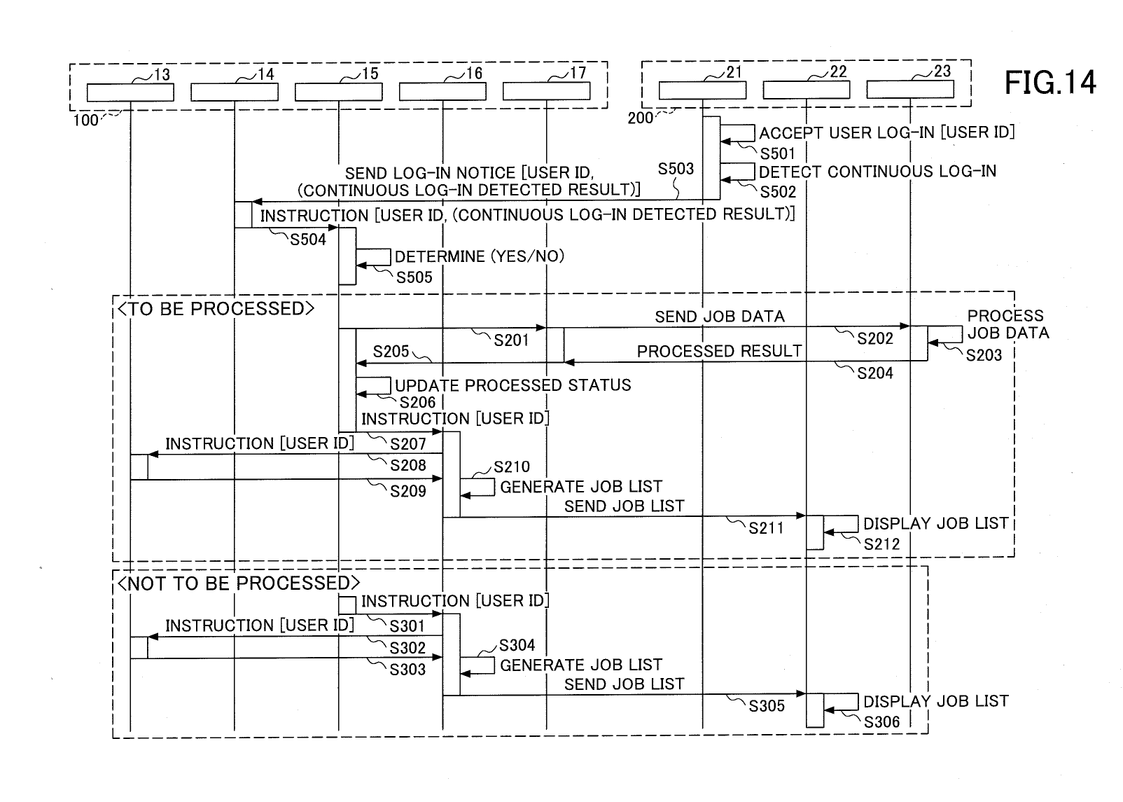

FIG. 14 is a sequence diagram showing an example of a job control process of the example.

As shown in FIG. 14, in the image processing apparatus 200, the log-in control unit 21 accepts a user log-in (step S501). At this time, the log-in control unit 21 performs a user authentication based on the authentication data of the user, and obtains the user ID of the log-in user.

When the user is authenticated, the log-in control unit 21 determines whether the current log-in user is the same as the previous log-in user based on the log-in history cached in the predetermined storage area, and detects a continuous log-in (step S502). At this time, the log-in control unit 21 compares the current user ID of the log-in user and the previous user ID of the log-in user stored in the log-in history, and determines whether the users are the same based on the compared result.

Then, the log-in control unit 21 sends the log-in notice with the continuous log-in detected result (if the continuous log-in is detected) to the log-in accepting unit 14 of the job control apparatus 100 (step S503). At this time, the log-in control unit 21 sends the user ID of the log-in user and the continuous log-in detected result to the log-in accepting unit 14 of the job control apparatus 100.

Upon receiving the user ID and the continuous log-in detected result, in the job control apparatus 100, the log-in accepting unit 14 instructs the job control unit 15 to determine whether the job data of the log-in user is to be processed (step S504). At this time, the log-in accepting unit 14 outputs user ID of the log-in user and the continuous log-in detected result to the job control unit 15.

Upon receiving the instruction from the log-in accepting unit 14, the job control unit 15 determines whether to process the job data of the log-in user based on the condition (step S505). At this time, the job control unit 15 determines to process the job data even when the job data is already processed based on the continuous log-in detected result when the condition JC1 is set.

When the job control unit 15 determines to process the candidate job data, the process proceeds to step S201. On the other hand, when the job control unit 15 determines not to process the candidate job data, the process proceeds to step S301.

The operation of step S505 is explained in detail.

### Detection of Continuous Log-in and Determining Whether to Process Job Data

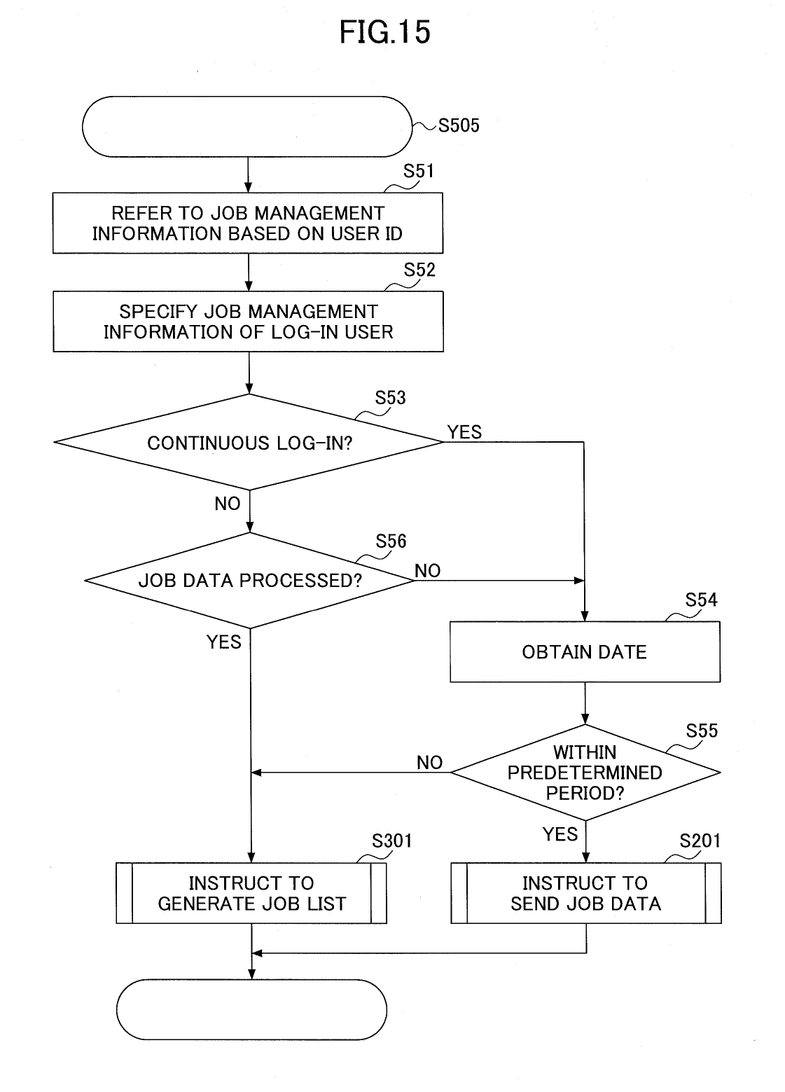

FIG. 15 is a flowchart showing an example of an operation of determining whether to process the job data of the example. In this example, it is assumed that the condition “JC1” that the “the job data is not processed yet” and the condition “JC2” that “the stored period of the job data is within a predetermined period” are stored as the conditions in the determining unit 151 with the priority of this order. Thus, FIG. 15 shows an example where whether the job data is to be processed is determined based on the processed status and the stored period of the stored job data.

First, whether the candidate job data of the log-in user is already processed is determined.

As shown in FIG. 15, the job control unit 15 refers to the job management information 90D of the job management information storing unit 90 based on the user ID of the log-in user (step S51), and specifies the job management information 90D of the log-in user (step S52). With this, the job control unit 15 specifies the candidate job data of the log-in user including the proxy user.

Subsequently, the job control unit 15 determines whether it is a continuous log-in by the same user based on whether the continuous log-in detected result is accepted with the log-in notice (step S53).

When the job control unit 15 determines that it is the continuous log-in by the same user (step S53: YES), the process moves to determine whether the stored period of the candidate job data of the log-in user is within the predetermined period.

The determining unit 151 obtains the date when the log-in notice is received by the clock circuit (not shown in the drawings) of the job control apparatus 100, and obtains the stored date of the stored data from the job management information 90D of the candidate job data (step S54).

The determining unit 151 of the job control unit 15 determines whether the stored period of the candidate job data is within the predetermined period based on the obtained date and the stored date (step S55).

When the stored period is determined to be within the predetermined period (step S55: YES), the determining unit 151 of the job control unit 15 determines to process the job data and instructs the job sending unit 17 to send the job data (step S201). Thus, the job control apparatus 100 sends the request to process the job data to the image processing apparatus 200 upon the log-in of the user.

On the other hand, when the stored period is determined to be over the predetermined period (step S55: NO), the determining unit 151 of the job control unit 15 determines not to process the job data and instructs the job list generating unit 16 to generate the job list of the log-in user (step S301). Thus, the job control apparatus 100 sends a request to display the job list to the image processing apparatus 200 upon the log-in by the user.

When the job control unit 15 determines that it is not the continuous log-in by the same user (step S53: NO), the determining unit 151 determines whether the specified candidate job data is already processed (step S56). At this time, the determining unit 151 determines whether the specified candidate job data is already processed based on the specified information about the processed status of the job management information 90D (processed status value).

When the determining unit 151 determines that the candidate job data is not processed yet (step S56: NO), the process moves to step S54.

On the other hand, when the determining unit 151 determines that the candidate job data is already processed (step S56: YES), the process proceeds to step S301.

As described above, according to the example, when the continuous log-in by the same user is detected at the image processing apparatus 200, even when the job data is already processed, the job control apparatus 100 determines to have the stored job data be processed upon the log-in of the user as a trigger.

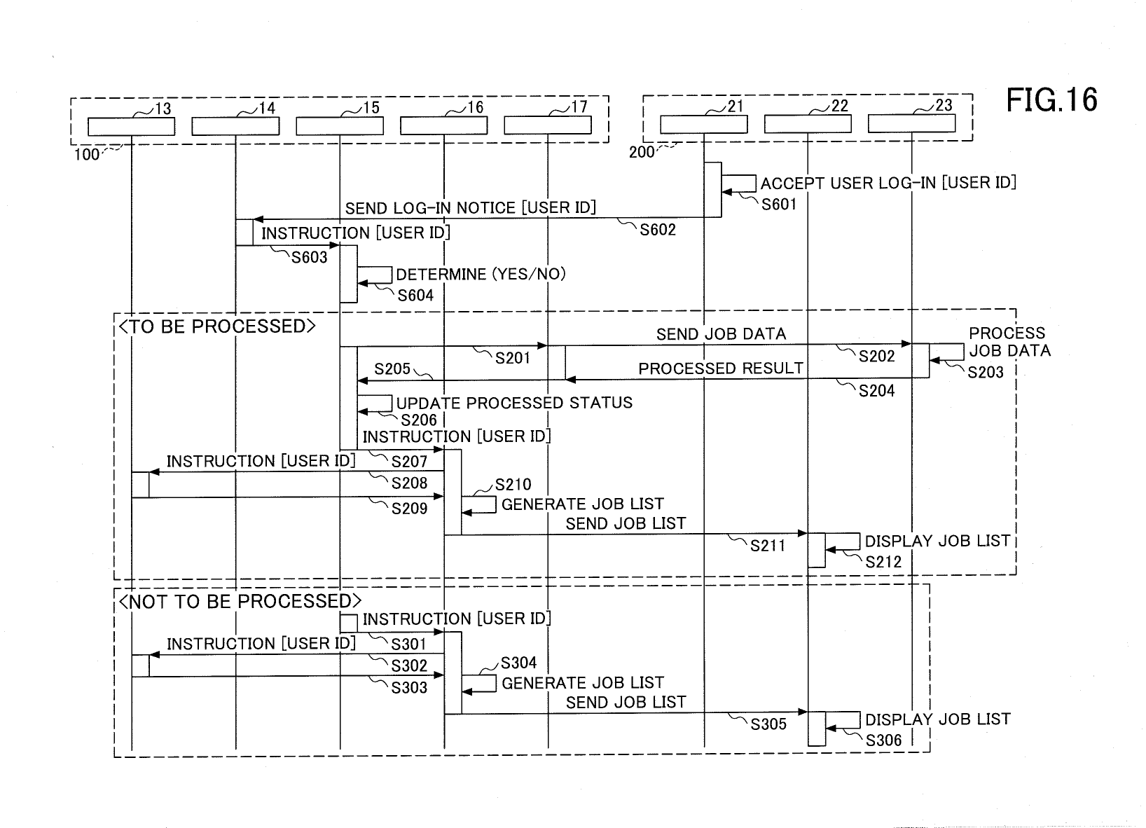

FIG. 16 is a sequence diagram showing another example of a job control process of the example.

As shown in FIG. 16, in the image processing apparatus 200, the log-in control unit 21 accepts a user log-in (step S601). At this time, the log-in control unit 21 performs a user authentication based on the authentication data of the user, and obtains the user ID of the log-in user.

When the user is authenticated, the log-in control unit 21 sends the log-in notice to the log-in accepting unit 14 of the job control apparatus 100 (step S602). At this time, the log-in control unit 21 sends the user ID of the log-in user to the log-in accepting unit 14 of the job control apparatus 100.

Upon receiving the user ID from the log-in control unit 21, in the job control apparatus 100, the log-in accepting unit 14 instructs the job control unit 15 to determine whether the job data of the log-in user is to be processed (step S603). At this time, the log-in accepting unit 14 outputs the user ID of the log-in user received with the log-in notice to the job control unit 15.

In this example, upon receiving the instruction from the log-in accepting unit 14, the job control unit 15 detects a continuous log-in by the same user. Subsequently, the job control unit 15 determines whether to process the job data of the log-in user based on the condition (step S604). The job control unit 15 first accesses the job management information storing unit 90, and specifies the job management information 90D of the log-in user based on the user ID of the log-in user. Then, the log-in control unit 15 determines whether it is the continuous log-in by the same user based on the period from the latest processed result in the specified information about the processed status of the job management information 90D.

After detecting the continuous log-in, the job control unit 15 determines whether the candidate job data is to be processed based on the continuous log-in detected result and the condition.

The operation of step S604 is explained in detail.

### Detection of Continuous Log-in and Determining Whether to Process Job Data

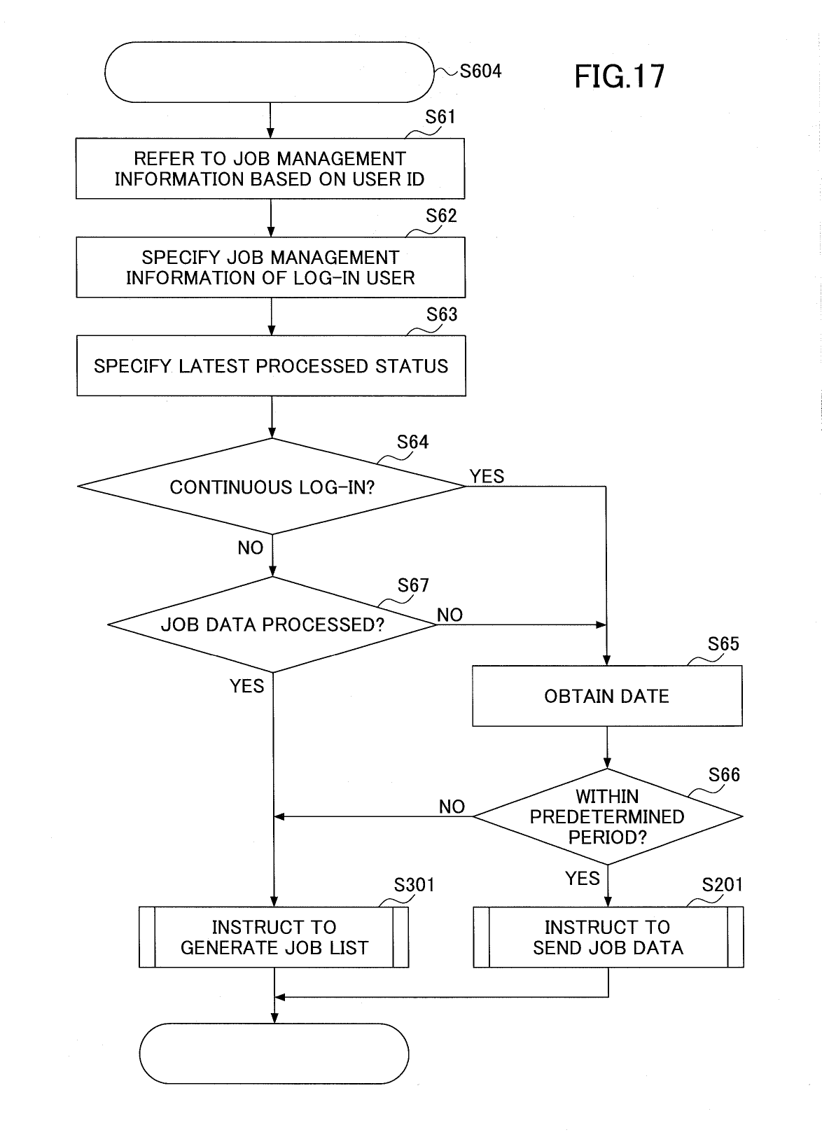

FIG. 17 is a flowchart showing an example of an operation of determining whether to process the job data of the example. In this example, it is assumed that the condition “JC1” that the “the job data is not processed yet” and the condition “JC2” that “the stored period of the job data is within a predetermined period” are stored as the conditions in determining unit 151 with the priority of this order. Thus, FIG. 17 shows an example where whether the job data is to be processed is determined based on the processed status and the stored period of the stored job data.

First, whether the candidate job data of the log-in user is already processed is determined.

As shown in FIG. 17, the job control unit 15 refers to the job management information 90D of the job management information storing unit 90 based on the user ID of the log-in user (step S61), and specifies the job management information 90D of the log-in user (step S62). With this, the job control unit 15 specifies the candidate job data of the log-in user including the proxy user.

Subsequently, the job control unit 15 specifies the latest information about the processed status based on the specified information about the processed status of the job management information 90D (step S63).

Subsequently, the log-in control unit 15 determines whether the period from the latest processed result is within the predetermined period based on the information about the processed status (step S64).

When the period from the latest processed result is within the predetermined period (step S64: YES), the job control unit 15 determines that it is the continuous log-in of the same user and the process moves to determine whether the stored period of the candidate job data of the log-in user is within the predetermined period. Then, the determining unit 151 obtains date when the log-in notice is received by the clock circuit (not shown in the drawings) of the job control apparatus 100, and obtains the stored date of the stored data from the job management information 90D of the candidate job data (step S65).

The determining unit 151 of the job control unit 15 determines whether the stored period of the candidate job data is within the predetermined period based on the obtained date and the stored date (step S66).

When the stored period is determined to be within the predetermined period (step S66: YES), the determining unit 151 of the job control unit 15 determines to process the job data and instructs the job sending unit 17 to send the job data (step S201). Thus, the job control apparatus 100 sends the request to process the job data to the image processing apparatus 200 upon the log-in by the user.

On the other hand, when the stored period is determined to be over the predetermined period (step S66: NO), the determining unit 151 of the job control unit 15 determines not to process the job data and instructs the job list generating unit 16 to generate the job list of the log-in user (step S301). Thus, the job control apparatus 100 sends a request to display the job list to the image processing apparatus 200 upon the log-in by the user.

Further, when the job control unit 15 determines that the period from the latest processed result is over the predetermined period (step S64: NO), the job control unit 15 determines that it is not the continuous log-in by the same user. Then, the determining unit 151 determines whether the candidate job data is already processed (step S67). At this time, the determining unit 151 determines whether the specified candidate job data is not processed yet based on the specified information about the processed status of the job management information 90D (processed status value).

When the determining unit 151 determines that the candidate job data is not processed yet (step S67: NO), the process proceed to step S65.

On the other hand, when the determining unit 151 determines that the candidate job data is already processed (step S67: YES), the process proceeds to step S301.

As described above, according to the example, when the continuous log-in by the same user is detected at the job control apparatus 100, even if the stored job data of the log-in user is already processed, if the stored period of the stored job data is within the predetermined period, the job data is determined to be processed again by the log-in by the user as a trigger.

According to the job control system 1 of the example, whether to process the job data upon the log-in of the user as a trigger can be determined based on the condition and whether it is the continuous log-in by the same user. Thus, according to the job control system 1 of the example, a more flexible service can be provided where convenience for the user can be improved while ensuring the security of the output result when the job data is already processed as well as obtaining the same merit as the above embodiment.

The “job control function” of the above embodiments can be performed by executing the programs in which the above processes explained with reference to drawings are coded in programming languages in accordance with the respective operating environments (platforms) by the arithmetic units (CPU) of the apparatuses (the job control apparatus 100, the image processing apparatuses 200, the information terminal 300 and the like) of the job control system 1.

The above programs may be stored in a computer readable recording medium 103a. With this, for example, for the job control apparatus 100, the above programs may be installed in the job control apparatus 100 via the external I/F 103. Further, as the job control apparatus 100 includes the communication I/F 107, the above programs may be downloaded using an electrical communication line and installed.

The individual constituents of the job control system 1 may be embodied by arbitrary combinations of hardware and software, typified by a CPU of an arbitrary computer, memory, a program loaded in the memory so as to embody the constituents illustrated in the drawings, storage units for storing the program such as a hard disk, and an interface for network connection. It may be understood by those skilled in the art that methods and devices for the embodiment allow various modifications.

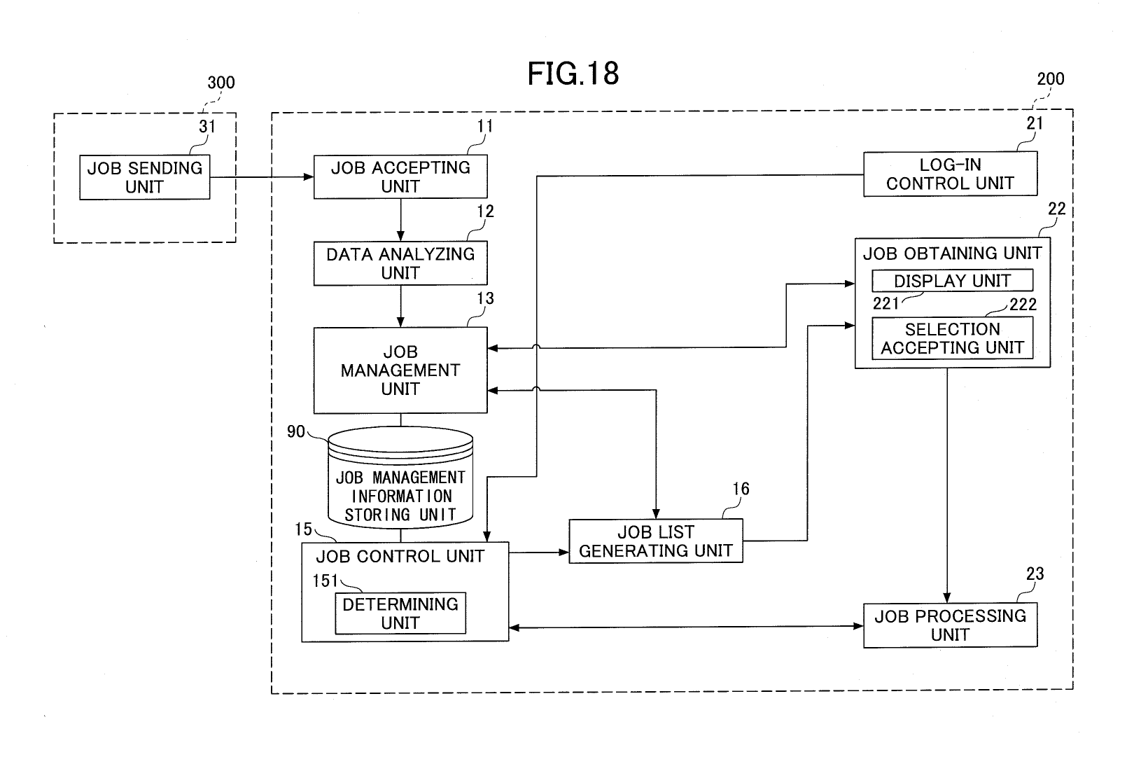

Further, in the above embodiment, an example in which the job control function is performed by the information terminal 300 that inputs the job data, the image processing apparatus 200 that processes the job data, and the job control apparatus 100 that manages the job data is explained. However, this it not limited so. The job control function may be performed by a structure shown in FIG. 18, for example.

FIG. 18 is a block diagram of showing an example of a structure of the job control function of alternative example 4.

In this example, the function of the job control apparatus 100 as explained above is incorporated in the image processing apparatus 200. With this, the image processing apparatus 200 may include the server function of providing the job control service.

Although a preferred embodiment of the job control system has been specifically illustrated and described, it is to be understood that minor modifications may be made therein without departing from the spirit and scope of the invention as defined by the claims.

The present invention is not limited to the specifically disclosed embodiments, and variations and modifications may be made without departing from the scope of the present invention.

The present application is based on Japanese Priority Application No. 2011-266845 filed on Dec. 6, 2011, the entire contents of which are hereby incorporated by reference.

What is claimed is:

1. A job control apparatus for controlling processing of job data by a job processing unit, comprising:
a job control unit that determines whether stored job data which is in correspondence with a user is to be processed by the job processing unit upon a log-in of the user to use the job processing unit as a trigger based on a previously set predetermined condition that allows the stored job data to be processed by the job processing unit upon the log-in of the user.

2. The job control apparatus according to claim 1, further comprising:
a job management information storing unit that stores job management information in which job management information of the job data is in correspondence with a user ID of the user; and
wherein the job control unit
receives the user ID of the user who has logged in to use the job processing unit,
specifies the job management information of the user based on the received user ID of the user, and
determines whether the stored job data which is in correspondence with the user is to be processed based on the previously set predetermined condition and the specified job management information of the user.

3. The job control apparatus according to claim 2,
wherein the previously set predetermined condition is that the stored job data is not processed yet,
the job management information storing unit stores information about a processed status indicating whether the job data is already processed or not in correspondence with the user ID, and
the job control unit determines whether the stored job data of the user is already processed based on the information about the processed status of the job data included in the job management information of the user, and determines that the job data is to be processed upon the log-in of the user when the job data is not processed yet.

4. The job control apparatus according to claim 2,
wherein the previously set predetermined condition is that a stored period of the job data is within a predetermined period,
the job management information storing unit stores information about a stored date of the job data in correspondence with the user ID, and
the job control unit determines whether the stored period of the job data is within the predetermined period based on the information about the stored date of the job data included in the job management information of the user, and determines that the job data is to be processed upon the log-in of the user when the stored period of the job data is within the predetermined period.

5. The job control apparatus according to claim 2,
wherein the previously set predetermined condition is that a data size of the stored job data is less than or equal to a predetermined value, the job management information storing unit stores the data size of the job data in correspondence with the user ID, and
the job control unit determines whether the data size of the job data is within the predetermined value based on the data size of the job data included in the job management information of the user, and determines that the job data is to be processed upon the log-in of the user when the data size of the job data is less than or equal to the predetermined value.

6. The job control apparatus according to claim 1,
wherein the job control unit
causes the stored job data to be processed by the job processing unit when the stored job data is determined to be processed upon the log-in of the user and
causes a job list of the stored job data of the user to be provided to the user when the stored job data is determined not to be processed upon the log-in of the user.

7. The job control apparatus according to claim 1,
further comprising a condition for a user storing unit that stores the previously set predetermined condition in correspondence with a user ID of the user
wherein the job control unit
receives the user ID of the user who has logged in to use the job processing unit,
specifies the condition for the user based on the received user ID of the user, and
determines whether the stored job data which is in correspondence with the user is to be processed based on the condition for the user.

8. The job control apparatus according to claim 1,
wherein the job control unit
requests an instruction from the user whether to process the stored job data upon the log-in of the user when the stored job data is determined to be processed, and
determines whether to actually have the stored job data be processed upon the log-in of the user based on the instruction from the user.

9. The job control apparatus according to claim 3,
wherein the job control unit determines whether the log-in of the user is a continuous log-in of the same user, and
determines that the job data is to be processed upon the log-in of the user even when the job data is already processed if the log-in of the user is the continuous log-in.

10. The job control apparatus according to claim 9, further comprising:
a job management information storing unit that stores job management information in which job management information of the job data including information about a latest processed date of the stored job data is in correspondence with a user ID of the user;
wherein the job control unit
receives the user ID of the user who has logged in to use the job processing unit,
specifies the job management information of the user based on the received user ID of the user, and
determines that the log-in of the user is the continuous log-in of the same user when the period from the latest processed date is within a predetermined period.

11. The job control apparatus according to claim 1, further comprising a condition storing unit that stores the previously set predetermined condition.

12. The job control apparatus according to claim 1, wherein the job processing unit is included in an electronic apparatus which is connected to the job control apparatus via a predetermined data transmission line,
the job control apparatus further comprising:
a log-in accepting unit that accepts a log-in notice of the user indicating that the user is logged into the electronic apparatus, and
a job sending unit that sends the stored job data which is determined to be processed upon the log-in of the user to the electronic apparatus with a request to process the job data.

13. A job control system comprising:
an electronic apparatus including a job processing unit that processes job data; and
a job control apparatus connected to the electronic apparatus via a predetermined data transmission line, including
a job control unit that determines whether stored job data which is in correspondence with a user is to be processed by the job processing unit upon a log-in of the user to use the job processing unit as a trigger based on a previously set predetermined condition that allows the stored job data to be processed by the job processing unit upon the log-in of the user.

14. A method of controlling processing job data by a job processing unit, comprising:
determining whether stored job data which is in correspondence with a user is to be processed by the job processing unit upon a log-in of the user to use the job processing unit as a trigger based on a previously set predetermined condition that allows the stored job data to be processed by the job processing unit upon the log-in of the user.
